(19) United States
(12) Patent Application Publication
(10) Pub. No.: US 2025/0177821 A1
(43) Pub. Date: Jun. 5, 2025

(54) METHODS AND APPARATUS FOR IMPROVEMENT OF SPORT BALL ACOUSTICS

(71) Applicants: Thomas Flitsch, Moorpark, CA (US); Frederick Flitsch, Framingham, MA (US)

(72) Inventors: Thomas Flitsch, Moorpark, CA (US); Frederick Flitsch, Framingham, MA (US)

(21) Appl. No.: 18/964,438

(22) Filed: Nov. 30, 2024

Related U.S. Application Data
(60) Provisional application No. 63/605,448, filed on Dec. 1, 2023.

(51) Int. Cl. A63B 37/00; A63B 102/08; B29D 22/04; B29K 75/00

(52) U.S. Cl. CPC A63B 37/0098; B29D 22/04; A63B 2102/08; A63B 2209/00; B29K 2023/06; B29K 2075/00

(57) ABSTRACT

Methods and apparatus for lowering an actual and perceived-sound level produced by sports equipment are described. In some examples, methods and apparatus to lower sound levels produced by pickleball balls are described. In some examples, internal surface features such as ribs, peaks, tabs, channels, divots, and damping layers may be applied. In some examples, composite layered designs may result in lowered amplitude and/or in shifted resonant frequencies. In some examples, heat or light sources may be used to alter the internal surfaces of ball constructs. In some examples the composite layered design may include isolated surface plates. In some examples, electroactive components may reduce sound emission. Methods of measuring a sound level at frequencies and using the measurement results to iteratively design ball designs are described.

### FIELD OF THE INVENTION

The present methods and apparatus relate to lowering a perceived sound level of sports ball acoustics by reducing generated sound amplitude or shifting the frequencies generated, specifically for balls used in paddle sports games including Pickleball.

### BACKGROUND OF THE INVENTION

Paddle sports have been dramatically increasing in popularity around the world. The games may have standard equipment rules for regulated play. In different environments, users may utilize different ball types for varied reasons. For example, the sport of pickleball may be played in an outdoor environment, or an indoor environment and distinct types of balls may be used for these different environments. Typically, such balls may include a material to form a hollow sphere shape that has penetration holes through its body. The size of the ball may vary in the different environments as well as the dimension and the number of holes. For example, as the pickleball sport increases in popularity, the complaints of noise from the game increases. While some solutions have been focused on reducing noise by attenuating noise with the design of court enclosures or altering the paddle features, the ball itself may present opportunity for variation that may alter the frequency or intensity of sound associated with the strike of the paddle and ball.

In many of these cases, the striking of the ball with a standard paddle may emit a characteristic “popping” sound that in some examples creates a perceived or actual noise level that may cause issues with the surrounds of the playing field. As well, sound is produced when the ball strikes a playing surface as well. Due to the standard nature of the pickleball design with a thin material, the striking creates higher frequency sound than may be typical for other sports. This may increase the perceived loudness of the sound emitted because the human perception of sound, within the frequency ranges related to this discussion, increases for an equivalent sound intensity in a relevant band. Accordingly, in some examples an alternative ball design based on foam material without holes in the body are used to reduce the levels of sound produced.

Although, actual and perceived-sound levels may be decreased with such a ball, a radical change to the characteristics of the ball in the game may occur, and, therefore, users may not accept the alternative. Therefore, a lower sound emitting pickleball with equivalent or near equivalent characteristics to a standard pickleball is desirable.

### SUMMARY OF THE INVENTION

Accordingly, methods and apparatus for creating low-sound-emitting sports equipment, and in some specific examples pickleballs are described in this disclosure. The devices and methods to measure, optimize and fabricate reduced sound emitting pickleballs may be applied to numerous other sports balls and such embodiments may be considered extensions of the present invention. According to one aspect of the present invention, an apparatus for reduction of sound level produced during a sporting activity includes an approximately spherical hollow perforated solid shell, wherein the outer surface is without topographic features, but the inside surface of the spherical shell has a plurality of surface features sticking out more than 0-1 mm and in some preferred examples less than 10 mm from the local surface.

According to another aspect, the apparatus for reduction of sound levels produced during a sporting activity wherein the plurality of surface features includes one or more of tabs, ridges, peaks, or ribs located on interior surfaces of a perforated solid shell or within the shell itself without showing features on either exterior or interior surface. The tabs, ridges, peaks, or ribs may be similar or dissimilar materials to the solid shell. Various material choices may achieve composite layers where the shell of the exemplary ball is of a different material than features within the shell or positioned across the inner surface. In some examples, features may occur within the shell body itself. Materials may be optimized to encourage the transmission of sound away from the shell of the ball towards the interior spaces. Other choices may include materials that may dampen sound travelling in the shell or in the interior spaces. In some examples, the shell may include interconnected plates that may have interfaces of material that may dampen, isolate, or allow flexation during a strike of the ball surface. In some examples, the protrusions may be formed of a size including its width, length, height, and material makeup that matches observed resonant frequencies of standard balls in vibration. In some examples protruding features may be encapsulated within films that dissipate sound and vibrations rather than transmit or emit them.

According to yet another aspect, the apparatus for reduction of a sound level produced during a sporting activity wherein the plurality of surface features includes one or more of trenches, cavities, or depressions within the shell itself or upon interior surfaces. In some examples, these features may have minimal sizing such as approximately 1 mm dimensions. In some examples, the feature may include a significant portion of the inner surface of the ball. In some examples, a repetitive occurrence of such feature may form a combination that while formed of smaller features, may in combination include most or all of the surface of the interior of the ball. In some examples, internal features may protrude into sound dissipating materials and induce energy from the sphere to vibrate into the resonance modes of the features. The internal features may be designed such that for the material aspects they are formed of they have dimensions whose resonance modes match natural frequencies measured for the balls without such features. In some examples, the internal features may be enclosed in another deposited layer of a damping material, where the internal feature dimensions may be further refined to match the previously targeted resonance modes.

According to one aspect of the present invention, a method of using an apparatus for the reduction of a sound level produced during a sporting activity comprises obtaining an apparatus used in the sporting activity, wherein the apparatus used in the sporting activity is configured to reduce a sound level produced during the sporting activity and wherein the apparatus comprises a first approximately spherical shell, wherein the first approximately spherical shell comprises an relatively smooth outer surface such as without topographic features sticking out more than 0.1 mm from the local surface; a plurality of holes penetrating through the spherical shell and located across the spherical shell; and a plurality of surface features upon an inner surface of the approximately spherical shell, wherein the inner surface is distally located from the outer surface in a direction towards a central point of the spherical shell; and striking the apparatus used in the sporting activity with a paddle or when the sphere contacts the play surface.

According to another aspect, a method of forming an apparatus for the reduction of a sound level produced during a sporting activity comprises creating a first concave shaped molding surface to mold an exterior or interior surface of at least a portion of a sports ball used in the sporting activity; creating a first convex shaped molding surface to mold an interior surface of at least a portion of a sports ball used in the sporting activity, wherein the first convex shaped molding surface comprises surface features to mold features upon the interior surface of at least a portion of the sports ball.

According to yet another aspect, the method wherein the surface features of the first convex shaped molding surface define one or more of tabs, ribs, trenches, or wells on the inner surface of the sports ball.

According to one aspect of the present invention, the method wherein the portion of a sports ball is a hemisphere.

According to another aspect, the method wherein the mold surfaces are combined to create a half sphere of the ball structure.

According to yet another aspect, the method wherein two of the half sphere structures are joined together to form a ball.

According to one aspect of the present invention, the method further comprises combining the first convex shaped molding surface and the first concave shaped molding surface to form an assembled mold to form at least a portion of a ball surface; and forcing a ball forming material into the assembled mold.

According to another aspect, the method further comprises combining the first convex shaped molding surface and the first concave shaped molding surface to form an assembled mold to form at least a portion of a sports ball surface; filling a ball forming resin into a sprue of the assembled mold; and rotating the mold to rotationally cast the at least a portion of the sports ball surface.

According to yet another aspect, the method wherein the first mold comprises tab features to define holes in the surface of the sports ball.

According to one aspect of the present invention, a method of forming an apparatus for the reduction of a sound level produced during a sporting activity comprises creating a first concave shaped molding surface to mold an exterior surface of at least a portion of a sports ball used in the sporting activity; creating a second concave shaped molding surface to mold an exterior surface of at least a portion of a sports ball used in the sporting activity; creating a third concave shaped molding surface to mold an insert piece to be positioned within an assembly comprising at least the first concaved shaped molding surface and the second concave shaped molding surface, wherein the insert piece formed by molding with the third concave shaped molding surface has a negative shape for a surface feature to be formed upon an inner surface of the sports ball; utilizing the third concave shaped molding surface to form the insert piece; assembling a first molding assembly comprising at least the first concave shaped molding surface and the second concave shaped molding surface around the insert piece such that a molding cavity is formed between the insert piece and the other molding surfaces; and using the first molding assembly to perform a molding process to create a sports ball.

According to another aspect, the method wherein the insert piece is formed of a material that will dissolve in a first solvent that does not dissolve the sports ball.

According to yet another aspect, the method further comprises placing the result of using the first molding assembly to perform the molding process into the first solvent.

According to one aspect of the present invention, the method wherein the first solvent is water.

According to another aspect, the method wherein the molding process on the first molding assembly involves rotationally casting a resin in the first molding assembly.

According to yet another aspect, the method wherein the insert piece defines the interior surface of at least a portion of a sports ball used in the sporting activity, and wherein a surface of the insert piece comprises surface features to mold features upon the interior surface of at least a portion of the sports ball.

According to one aspect of the present invention, the method wherein the first mold comprises tab features to define holes in the surface of the sports ball.

According to one aspect of the present invention, the method may include the formation of tab features which are branded or welded onto a hemisphere of a shell before or after holes in the shell of the ball are imparted. The branded or welded features may be included onto the inner surface of the sports ball before two hemisphere's are joined to create the ball.

According to another aspect, a method of using an apparatus to reduce a sound level produced in a sporting activity comprises forming the apparatus to reduce a sound level, wherein the apparatus comprises a first approximately spherical perforated hollow shell, wherein the first approximately spherical shell comprises an outer surface without topographic features sticking out more than 0.1 mm from the local surface; a plurality of holes penetrating through the spherical shell and located across the spherical shell; and a plurality of surface features upon an inner surface of the approximately spherical shell, wherein the inner surface is distally located from the outer surface in a direction towards a central point of the spherical shell, wherein the forming of the apparatus to reduce a sound level comprises the steps of creating a first concave shaped molding surface to mold an exterior surface of at least a portion of a sports ball used in the sporting activity; creating a second concave shaped molding surface to mold an exterior surface of at least a portion of a sports ball used in the sporting activity; creating a third concave shaped molding surface to mold an insert piece to be positioned within an assembly comprising at least the first concaved shaped molding surface and the second concave shaped molding surface, wherein the insert piece formed by molding with the third concave shaped molding surface has a negative shape for a surface feature to be formed upon an inner surface of the sports ball; utilizing the third concave shaped molding surface to form the insert piece; assembling a first molding assembly comprising at least the first concave shaped molding surface and the second concave shaped molding surface around the insert piece such that a molding cavity is formed between the insert piece and the other molding surfaces; and using the first molding assembly to perform a molding process to create a sports ball; and striking the apparatus used in the sporting activity with a paddle or the sphere making contact with the playing surface

### BRIEF DESCRIPTION OF THE DRAWINGS

The accompanying drawings, which are incorporated in and constitute a part of this specification, illustrate several embodiments of the invention and, together with the description, serve to explain the principles of the invention:

FIG. 1A shows an illustration of a standard form of pickleball sports equipment.

FIG. 1B shows an illustration of a modified sports apparatus according to the present disclosure.

FIG. 1C illustrates sound production and dynamics in sports equipment.

FIG. 1D shows exemplary sound measurements for ordinary form pickleball sports equipment.

FIG. 1E shows sound measurements for alternative form tennis ball sports equipment.

FIG. 1F shows an exemplary common pickleball frequency spectrum with highlighted features for sound measurement experiments by dropping the ball.

FIG. 1G illustrates exemplary methods for obtaining dropped ball sound measurements.

FIG. 1H shows an exemplary common pickleball frequency spectrum with highlighted features for sound measurement experiments by dropping steel ball bearings against a common pickle ball.

FIG. 1I illustrates exemplary methods for obtaining dropped steel ball bearings against a common pickle ball for sound measurements.

FIG. 1J illustrate hearing iso-levels for different emitted sound levels versus frequencies.

FIG. 1K illustrates common polymer hardness scales as used in examples herein.

FIG. 2A illustrates a cross-section of a modified sports apparatus with internal ribs or tabs for sound reduction.

FIG. 2B illustrates a cross-section of a modified sports apparatus with an internal damping material for sound reduction.

FIG. 2C illustrates a cross-sectional view of a modified sports apparatus with an aerogel or open cell foam type layer for sound damping.

FIG. 2D illustrates a cross-sectional view of a modified sports apparatus with a second layer for sound damping.

FIG. 2E illustrates a cross-sectional view of a modified sports apparatus with isolated plates and damping layers.

FIG. 2F illustrates a cross-sectional view of an exemplary modified sports apparatus with an aerogel or similar type material layer internal cavities and electroactive elements.

FIG. 2G illustrates combination of internal hard structures and intermediate layers.

FIG. 2H illustrates exemplary ball designs with variations in hole aspects.

FIGS. 2I-2L illustrate exemplary hole wall designs.

FIG. 2M illustrate exemplary designs where “holes” are covered with structure.

FIG. 2N illustrate exemplary designs where the body of the ball structure is filled with materials.

FIG. 2O illustrate exemplary designs with ridge designs based on resonant frequencies of the ball they are attached to with damping layers applied as well.

FIG. 2P illustrate exemplary designs with ridge designs based on resonant frequencies of the ball.

FIGS. 3A and 3B illustrate peaks associated with resonance modes of balls.

FIG. 3C illustrates peaks associated with dropped balls across the audible spectrum.

FIG. 3D illustrates noise levels in experimentally altered pickleballs.

FIG. 3E illustrate noise levels in experiments with hole aspects in pickleballs.

FIG. 3F illustrate frequency aspects on experiments with hole aspects in pickleballs.

FIGS. 3G-3I illustrate exemplary aspects of a plated ball design.

FIG. 3J illustrates experimental results of a plated ball.

FIG. 4 illustrates a flow chart diagram of a method for forming a sports ball with an insert piece defining the interior surface.

FIG. 5 illustrates a flow chart diagram of a method for forming a sports ball using a molding assembly.

### DETAILED DESCRIPTION OF THE INVENTION

While the invention has been described in conjunction with specific embodiments, it is evident that many alternatives, modifications, and variations will be apparent to those skilled in the art in light of the foregoing description. Accordingly, this description is intended to embrace all such alternatives, modifications and variations as fall within its spirit and scope.

Accordingly, methods and apparatus for creating low sound emitting sports equipment, and in some specific examples pickleballs are disclosed in this disclosure, but the described concepts may apply to other paddle sport balls as well.

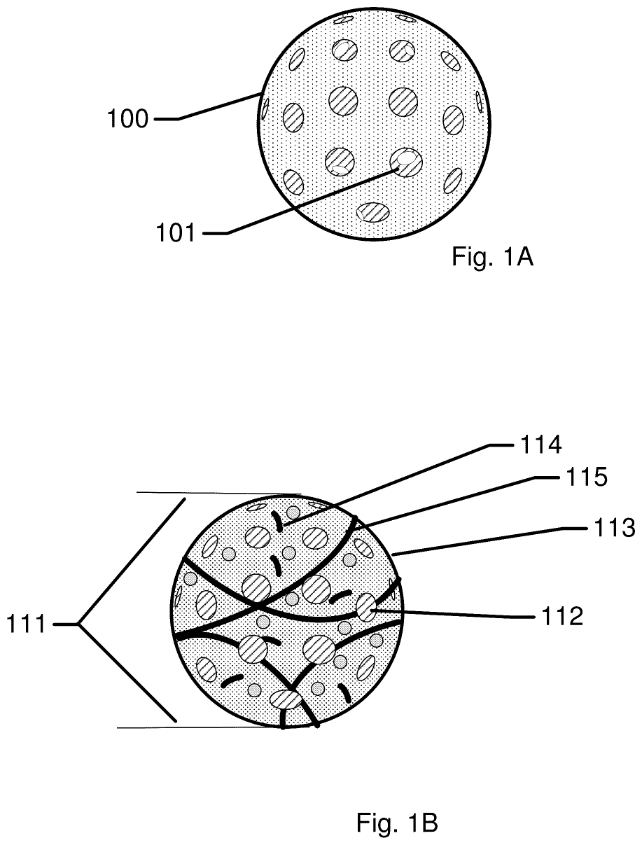

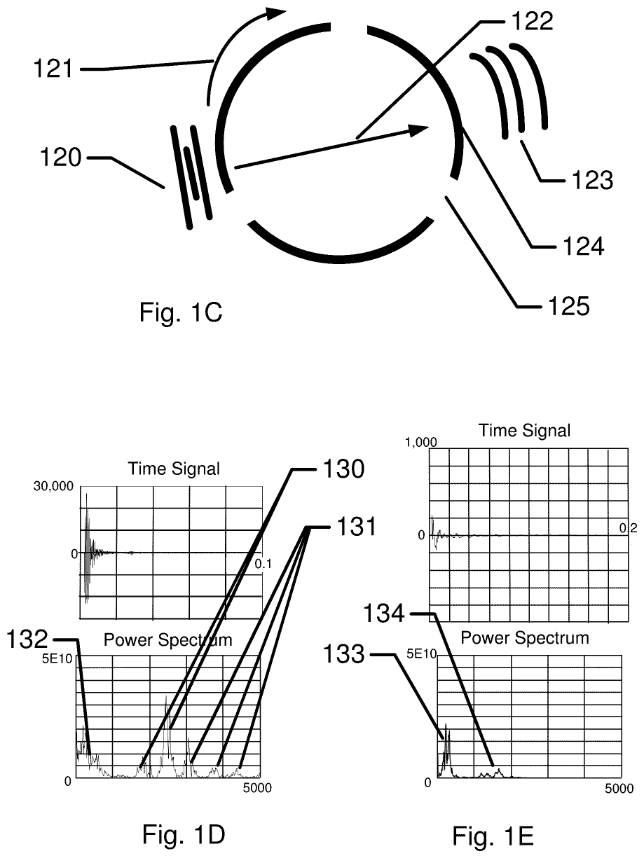

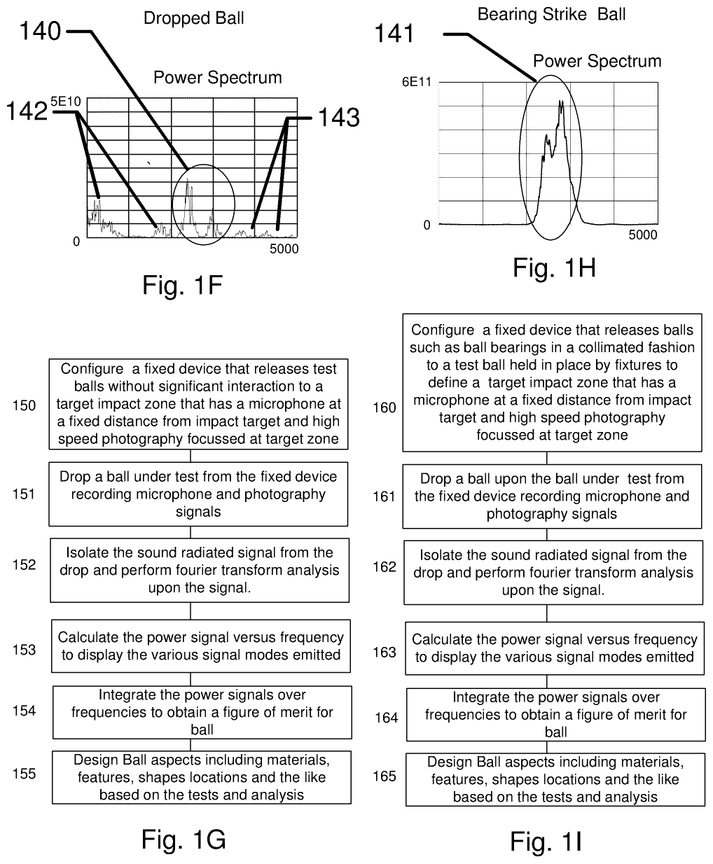

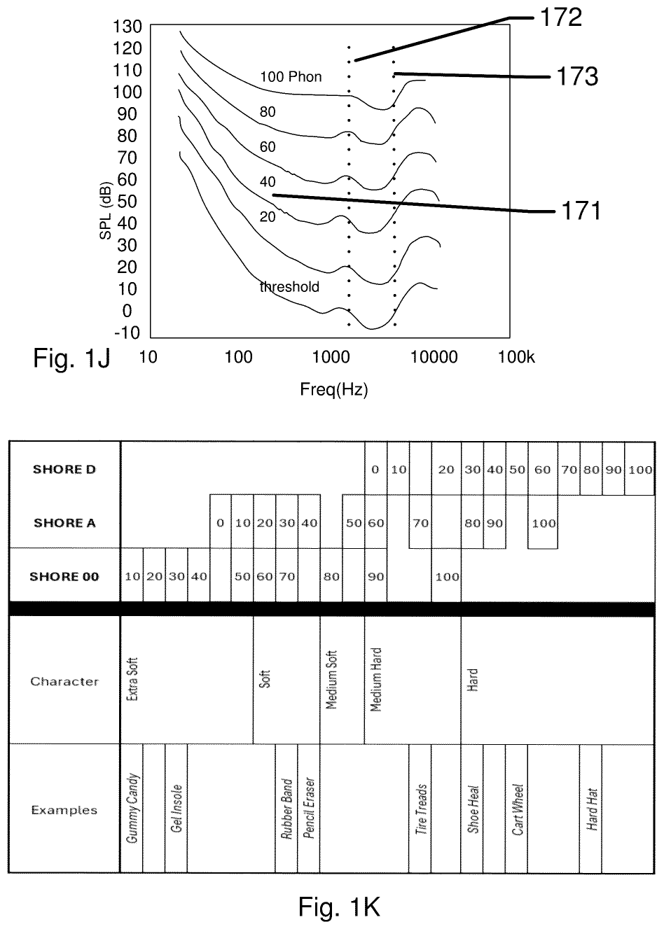

Referring now to FIG. 1A of a standard pickleball is illustrated. The pickleball may be a spherical shell object with smooth thin areas 100 interrupted by holes 101 in the spherical shell. There may be a number of parameters that such a standard pickleball may meet. For instance, in some examples, the ball may be made of smooth surface material, typically a plastic, resin, other polymer or other material that may be molded into form. In some examples, the pickleball may be of a uniform color. In some examples, a pickleball may have between 26 and 40 holes which may be circular and evenly spaced across the surface of the spherical ball surface. In testing a ball, an acceptable ball may bounce between 30 and 34 inches (762 and 864 mm) when dropped from a height of 78 inches (1,981 mm). The roundness of the ball may not deviate from a true sphere by more than 0.02 inches (0.5 mm). In standard examples, the weight of the ball may be between 0.78 ounces and 0.935 ounces (22.11 gm. to 26.51 gm.). As well, the diameter of the ball may be between 2.874 and 2.972 inches (73 mm to 75.5 mm). Some examples of the current disclosure may have some or all of these parameters outside these standard ranges.

There may be manners of changing materials and/or designs of the pickleball to improve the levels of sound emitted by the ball as it is struck during a usage. Referring now to FIG. 1B, an example of a device to reduce sound production of a pickleball is illustrated. Although some examples may use a subset of the elements portrayed in FIG. 1B, the illustration includes a standard pickleball diameter 111 (for either outside use or inside use), with a standard external surface, weight, and materials as a non-limiting example. The pickleball may also include standard holes including their size, shape, and count number in a standard pattern 112. There may be features added within the inside of the ball for the purposes of reducing noise and to ensure that the ball weighs a standard amount even with these features, the thickness of the outside shell 113 may be adjusted to offset any weight difference. In some examples, damping tabs 114 may be placed on the interior of the pickleball. The damping tabs 114 may have a variety of sizes or may all be the same size and they may be placed at numerous locations.

Modelling of, or experimentation with, damping tabs 114 placed in various locations may be optimized to adjust both intensity levels and perhaps frequencies of the sound produced by a struck pickleball. In some examples, damping ribs 115 may be placed instead of or in addition to damping tabs 114. In some other examples, both damping ribs 115 and damping tabs 114 may be used. In some examples, the damping tabs 114 and damping ribs 115 may be formed of the same materials as the outside shell, such as polymer or other materials as discussed in following sections and may be molded at the same time. In some other examples, the damping tabs 114 and damping ribs 115 may be formed of a different material such as an elastic material or sound absorptive or vibrational damping material that may in a non-limiting example be silicones, rubbers, foams, or other such materials. In other examples, the different material may include hard materials such as metals of various kinds. Tabs and ribs have been depicted, but the features may also be such items as ridges, trenches, peaks, valleys, craters, and other irregularities of the surface. Some examples with non-standard ball diameters and wall thicknesses and for other types of sports balls are within the scope of the present disclosure.

Proceeding to FIG. 1C, a rough model of how sound may be produced by a pickleball in play is illustrated. A paddle or other surface such as the court surface may strike a ball and create a vibration wave 120, emitting sound outright, but also creating the vibration wave which will travel across the spheroid surface 121 as well as transiting through the interior 122 region of the pickleball. These transit phenomena may result in emitted sound 123 across the entire sphere for either or both of the sphere body 124 or the holes 125 in the sphere body. The emission process may be quite complex. In a first point, the speed that vibrations travel through the solid (typically plastic) pickleball shell may be on the order of 2000 m/sec whereas through the air may be about 350 m/sec. Thus, the vibrations that pass through the solid material will easily reach the other side of the pickleball much faster than the sound through the ball. There may be constructive and destructive interference effects between the sound waves and other effects such as fluid properties of the air and the interaction with the holes. Further, the efficiency of transfer of vibrations in solid material to the air may be low. However, the time for the sound to traverse the perimeter of the ball may be related to travelling roughly 6 times faster for a distance that is about 1.57 times the diameter distance that the sound that directly traverses the ball interior would travel. For the diameter (75 mm) of a standard pickle ball, the external vibrations may reach the distal side from the paddle hit in 1.57*0.075 m/2000 m/sec or about 60 microseconds when travelling through the shell or about 214 microseconds across the center of the sphere, in a simple model. The wavelength of sound at 2000 Hz in Air is about 0.17 meters. Whereas that sound would travel about 0.0525 meters in the difference of time between the two paths. The emission of vibrations in the sphere body 124 into either the interior air or the exterior air may be a relatively inefficient process based on, among other things, the acoustic impedance of the surfaces and interfaces and the air. For typical solids, acoustic impedances of the order of 10⁵-10⁶ Rayls may be common as compared to Air at 10²-10³ Rayls depending on temperature and pressure which may represent a significant mismatch. When there is a mismatch significant reflection of vibrational energy rather than transmission may occur and less than 5% or even less than 1% may be transmitted. Nevertheless, as pickleballs do emit characteristic sounds, vibrational energy does convert to sound by various mechanisms. Furthermore, the presence of holes in the solid shell may allow for sound emission through the holes. It may be apparent that a significant number of processes may occur to emit sound of a complex nature given this environment.

The travel of sound through the sphere shell 121 and within the air of the interior 122 space may have resonance characteristics. Although the coupled aspects of all vibrational modes and of the impact of holes may create complicated models, basic/simplified models are instructional. For example, standing wave resonances for the internal air of the sphere may be estimated by the formula:

$${f}_{air} = \frac{c}{2 l} n$$

where c is the speed of sound in air (≈343 m/s), L is the effective diameter of the sphere (≈0.073 m), and n is the mode number (=1 for fundamental mode) which when evaluated gives about 2.35 kHz.

For example, resonance modes of the sphere body (as an example using HDPE as the material may be modeled by the following formula.

$${f}_{shell} = \sqrt{\frac{{m}_{shell}}{{m}_{shell} + {m}_{air}}} * \frac{1}{2 π} * \sqrt{\frac{2 ( 2 + 1 ) E t}{12 ρ {R}^{2} ( 1 - {v}^{2} )}}$$

where m (shell) the mass of the sphere is ˜25 gm, and m (air) the mass of the air within the sphere is ˜0.5 gm, and E the Young's modulus for HDPE is about 0.8 GPa, n is the mode number, and .t is the thickness of the sphere about 1 mm, and p(rho) the density of the sphere for HDPE of ˜950 kg/m³, and v(nu) the Poisson's ratio of ˜0.4 for the sphere system. Evaluating with these estimated parameters a fundamental frequency of about 8.9 kHz may be estimated. Since the system including these modes interacts and also includes penetrations which may also induce other modes which may couple to these estimated fundamental frequencies it may be anticipated that some shifting and splitting of these estimated mode frequencies may occur. Nevertheless, it may be instructive to consider modes in these regimes (as well as their harmonics) as being related to the fundamental types of modes.

Proceeding to FIGS. 1D and 1E, a comparison of spectral response during striking of the ball to the audio signal that emerges is made for a pickleball FIG. 1D and a Tennis Ball 1E. Generally speaking, a tennis ball may be perceived to emit less noise during play than a pickleball. The spectrum of FIG. 1D of the pickleball, obtained using techniques described in following sections, shows peaks around 1800 Hz and 2400 Hz 130 with significant signal character both at lower frequencies 132 and at higher frequencies 131. In subsequent discussions, the presence of features in the frequency ranges for the two estimated modes may be found and these ranges in fact demonstrate the dominant observed sound frequencies in some examples. In contrast, a measured tennis ball sound spectrum as illustrated in FIG. 1E has peaks 133 around about 40 Hz to 300 Hz and much less higher frequency components 134 compared to the pickleball spectrum.

Referring now to FIG. 1F obtained experimental data from measurements on pickleball samples is illustrated when obtained by a technique called the “dropped ball” technique which is further described in reference to FIG. 1G. At step 150, a user may configure a fixed device that releases test balls without significant interaction to a target impact zone that has a microphone at a fixed distance from impact target and high speed photography focused at target zone. The height of the fixed device may be adjustable but for given experiments may be kept consistent for comparative purposes. At step 151, a user may drop a ball under test from the fixed device recording microphone and photography signals. It may be apparent that since a pickleball includes holes of various patterns, which may intentionally interact with the air foil surrounding the pickleball, a result of a controlled and consistent drop may nevertheless include some random movement of the ball both rotationally and translationally from the exact target zone. In fact, in experiments, it is observed that such variation may occur and that the amount of sound that results from different drops may form various “buckets” of excitation types which may be sorted based on photography for example to allow for more fundamental characterization of sound produced by the ball. For example, effects such as the ball striking the target zone near a hole in its body may result in lower amplitude than when the ball strikes a portion of the sphere body away from a hole. Such factors as the level of deformation of the ball during strike being different based on different local strength of the sphere body may be important. Furthermore, as a ball approaches a surface, the amount of air that is “trapped” between the ball surface and the target surface may differ when an edge of a hole is involved. Finally, it may be apparent that when a hole is part of the impact dynamic that pressurization of air within the sphere may be more directly resulted than when the impact is purely on parts of the sphere body alone. There may also be coupling of the vibrations present in the surface with the sphere, which may result particularly in lower and higher mode frequencies of sound being produced. The resulting experiments, nevertheless, probe and model real world situations since in use the balls behave with these various dynamics.

Continuing with Step 152, a user may Isolate the sound radiated signal from the drop and perform Fourier transform analysis upon the signal. In some examples, sounds from the releasing of the ball for example may be present in recorded sound data. Fortunately, these background sounds are separated in time from the actual sound generated by impact and the signal of the impact may be isolated for further processing. To gain fundamental understanding of the nature of sound emanating from the collision, the sound amplitude versus time signals, such as illustrated at the top of FIG. 1D may be processed digitally using standard algorithms such as using a fast Fourier transform on the data. The result of such a process may be a representation of signal strength versus frequency. In some examples, background noise that may be present in the test environment that may have particular frequency characteristics may be normalized out of sample data if significant.

Continuing with Step 153 a user may calculate the power signal versus frequency to display the various signal modes emitted. At Step 154, the calculated power signal may be processed by algorithms to integrate the power signals over frequencies to obtain a figure of merit for sound produced by a ball during experiments. In some examples, it may be practical to isolate only frequencies that are within human audible frequencies and some microphones may be able to detect signals significantly limited to such a regime such as 20 Hz to 20 kHz. In other examples, more refined equipment may allow for obtaining frequency responses outside these bands. Continuing with Step 155 a user may design Ball aspects including materials, features, shapes, locations, and the like based on the “dropped ball” test methods and analysis.

In some examples, it may be desirable to configure a test set up that allows for more control over the nature of the region of a test ball surface being stricken. In some examples, hammers or solenoid pin surfaces may be used to strike a surface of a test ball which is held in place. In some examples, it may be important that the methods to hold the ball in place do not fundamentally constrain the vibrational modes which the user hopes to probe with the test. In some examples, elastic type fixtures may be attached to the test ball in various manners and then held to a structure that is rigidly held in place. In some examples, the elastic fixtures may be fed through a plurality of holes. In some other examples, the elastic fixtures may be attached to the test ball with adhesives or tapes, Elastic fixtures may be desirable because the ability to transfer vibrational energy from the attached balls out of the ball system may be minimized with such means. Other attachment materials and means may be used in other examples. For elastic fixture examples, it may be apparent that low frequency modes of the ball oscillating in space the frequency of which may be determined by the ball frequency and the elastic constants may occur such as in the 1 Hz-50 Hz regime, and accordingly such frequencies may be excluded from data when assessing sound production.

Continuing with FIG. 1H, a frequency spectrum result from a different type of test called a “dropped steel ball” test is illustrated. In these experiments, as described in FIG. 1I a relatively low weight steel ball bearing is dropped in a controlled manner upon a test ball held in the manners as described. It may be expected that there may be less interaction between the ball and its environment in these types of experiments and that therefore more control of the regions being excited and the nature of modes excited may result. In some examples, the excitation of various fundamental modes may nonetheless have distinct characteristics in such an experiment, and it may be useful to perform experiments of numerous types to gain a full understanding of the nature of changes that different ball types may give for sound generation during practical use of sport balls. At Step 160, a user may configure a fixed device that releases balls such as ball bearings in a “collimated” fashion to a test ball held in place by fixtures to define a target impact zone. In some examples, the configuration may also have a microphone or other sound detection apparatus at a fixed distance from an impact target. In some examples, high speed photography may be used when focused at the target zone to allow for categorization of different regions of excitation. In some examples of tests using such a technique, different actual regions of striking may still result in different sound level production. In some examples, the frequency results may be relatively consistent between such events with amplitudes being the characteristic difference.

Test data may be binned based on photographic evidence to allow for more consistent populations of data to be compared-affording more statistically valid categorization between different test balls and measured sound characteristics. Continuing with Step 161, a user may drop a steel ball upon the ball under test from the fixed holding devices while recording microphone or other sound detection apparatus and photography signals. At Step 162, a user may process a detected signal stream from steel ball drop experiments to isolate the sound radiated signal from the drop and perform Fourier transform analysis upon the signal. As mentioned previously, such signal processing may allow for more fundamental understanding of the sound characteristics and may also allow for the removal of “noise” from experimental data. For example, as mentioned it may be practical to remove the portions of the sound data at less than 50 Hz to remove the influence of the elastic holding structures from the data as a non-limiting example.

Continuing with Step 163 a user may calculate the power signal versus frequency to display the various signal modes emitted. At Step 164, the calculated power signal may be processed by algorithms to integrate the power signals over frequencies to obtain a figure of merit for sound produced by a ball during experiments. In some examples, it may be practical to isolate only frequencies that are within human audible frequencies and some microphones may be able to detect signals significantly limited to such a regime such as 20 Hz to 20 kHz. In other examples, more refined equipment may allow for obtaining frequency responses outside these bands, which in some examples may allow for understanding changes to the balls which may move audible sound production into modes that are not audible. Continuing with Step 165 a user may design Ball aspects including materials, features, shapes, locations, and the like based on the “dropped steel ball” test methods and analysis. Referring back to FIGS. 1F and 1H, it may apparent that in the 2400 Hz. region both the Dropped Ball method 140 and the Dropped Steel Bearing 141 show peaks. However, the rest of the spectral regions between 0 Hz and 5 kHz show many more features 142, 143 in the dropped ball results perhaps due to coupling of surface modes with the various ball modes.

Referring to FIG. 1J, as mentioned previously the human hearing sense, on average may have peaked frequency dependencies. The curves 171 illustrated in FIG. 1J represent a logarithmic plot of “equal sound perception” versus frequency. Accordingly, the low points on each curve may represent the most sensitive frequencies for hearing. In reference, between about 2000 Hz 172 and 5000 Hz 173 may be the most sensitive. The different curves represent the sensitivities between low sound levels at the bottom of the graph to high sounds at the top. As sounds become more intense, the sensitivity may shift towards higher frequencies but still within the 2 kHz and 5 kHz regime. Accordingly, strategies which lower total sound levels or alternatively shift sound from the 2 kHz-5 kHz region to other regions may result in lower perceived-sound levels from the balls. The previously mentioned tabs and ribs and other ball designs as described herein may interact with sound generation resonant modes and lower the energy emitted and or shift to frequencies of lower human sound perception.

For reference, an illustration of the characteristics of polymer materials, plastics, elastomers, and foams in terms of hardness scales is illustrated in FIG. 1K. When materials are picked for various aspects herein, it may be noted that different monomer characteristics of the general formulations may result in different polymer characteristics such as in the hardness of the resulting materials. Various alternative polymers may be used interchangeably with numerous examples herein where the polymers may be plastics, elastomers, foams, adhesives, fibers, coatings, biopolymers, and composites as non-limiting examples.

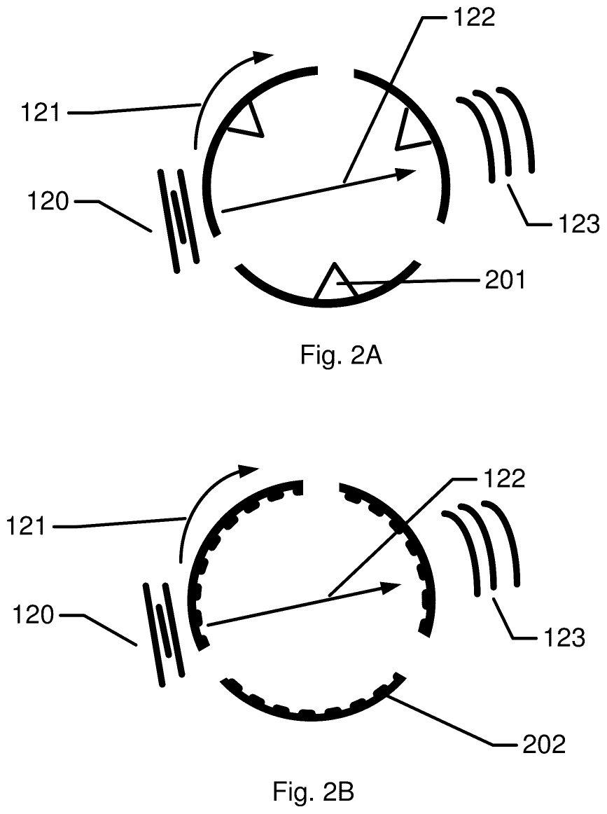

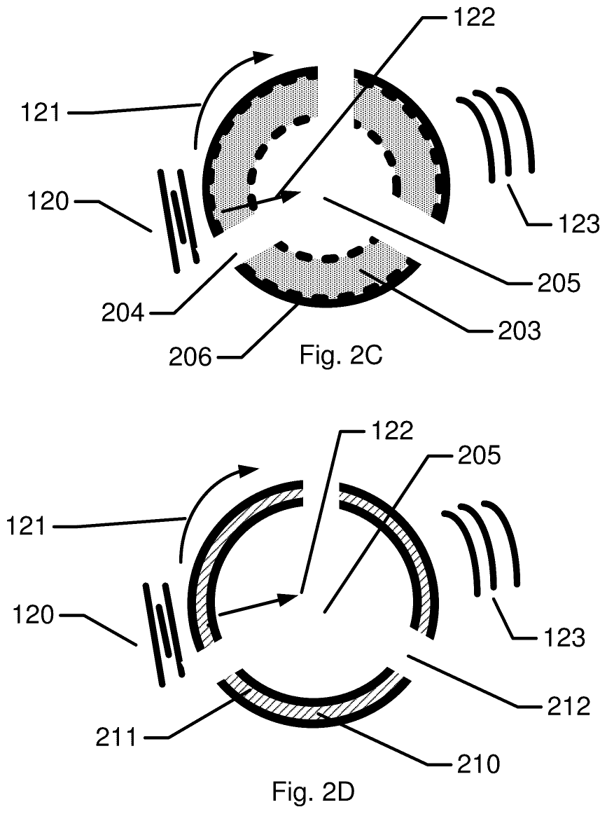

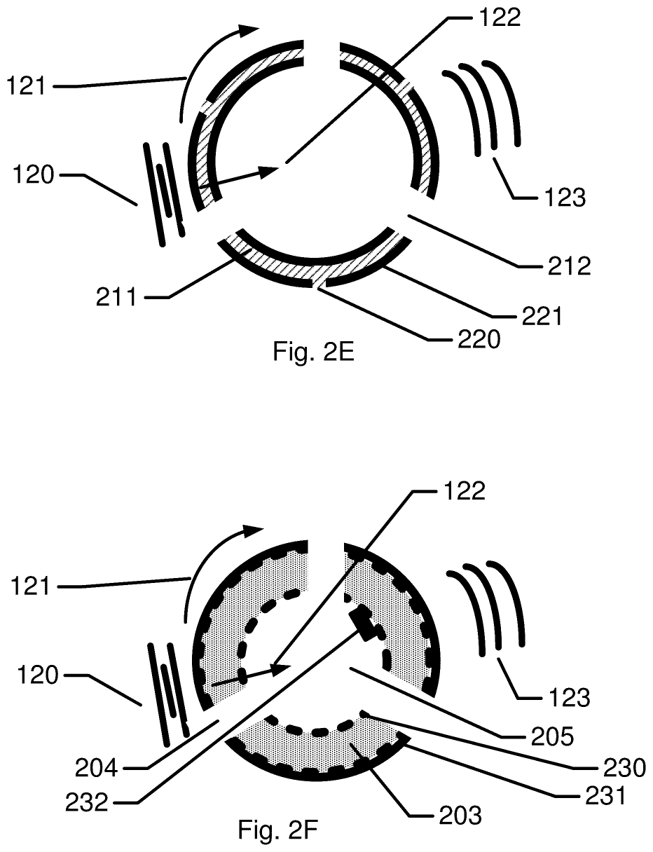

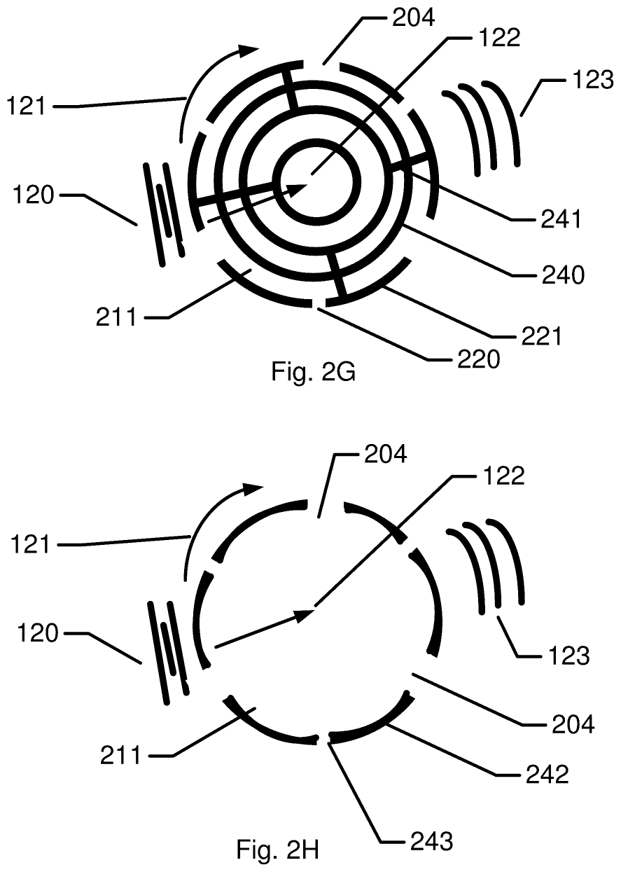

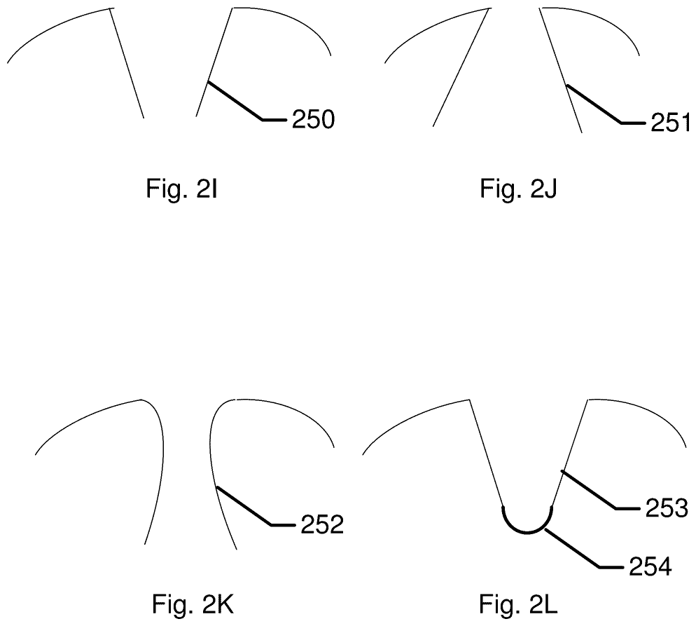

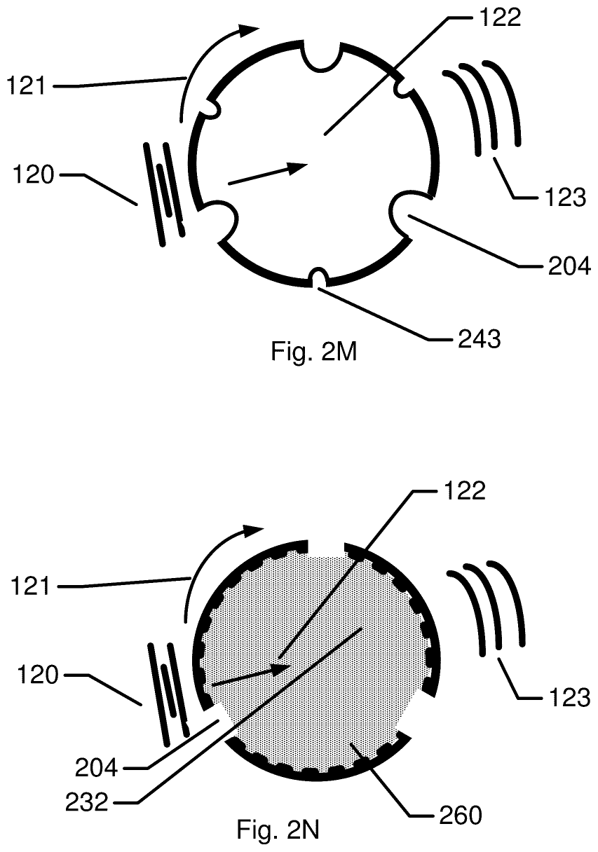

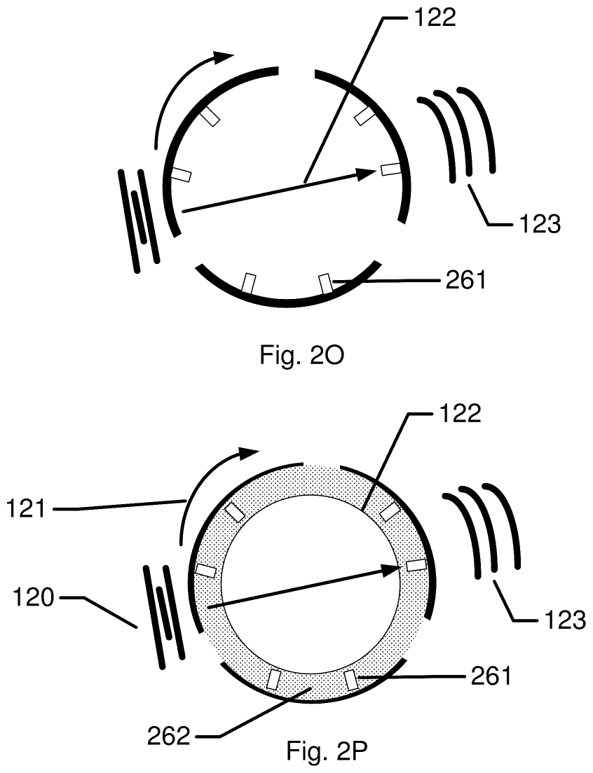

Referring to FIG. 2A, a cross section illustration of a pickleball with ribs or tabs 201 is illustrated. The ribs and tabs 201 located on the internal surface of the ball shell may function to scatter vibrations 120 transferred through the interior 122 of the ball. In some examples, the ribs and tabs 201 may transfer some of the vibrational energy transferring around the spheroid surface 121 and emit the energy (with some loss) into the interior of the ball. Emitted sound 123 may emerge from the ball. In some examples, the tab and rib features may be recessed into an interior surface of the ball and may be considered trenches and/or cavity structures with various shapes. The internal features may be formed of various types of materials and may be formed of multiple of these various types of materials. The materials to form internal features may include plastics, other polymers, adhesives, and other sound absorbing materials and the like. In some examples, a resonant frequency of the sphere shell may be altered by the presence of internal structure within the ball. These effects may either or both reduce an emission of acoustic energy from the pickleball or shift frequencies. There may be numerous designs of the location and dimensions of the tabs and ribs. The shapes of the features may have varying degrees of complexity and in some examples may have a fractal shape aspect which may increase an effective surface are of the features as well as having other benefits. There may be regular shapes such as rectangular, semicircular, triangular and the like used for the design. In other examples, there may be irregular shapes utilized. Designs may iteratively be formed to test whether a location of ribs and tabs reduce the sound levels, reduce the frequency levels and whether a design has a “feel” or response similar to a standard pickleball. The dimensions of the outer shell such as its thickness may be modified such that a ball with these design feature meets size and weight specifications. The designs of the tabs and ribs may include factors such as weight balancing or symmetric placement to ensure that the tabs do not cause irregular ball movement due to the effect of gravity, air resistance or balance. Furthermore, in some examples, the tabs, cavities, trenches, and ribs may be oriented such that aerodynamic factors of air moving around the outside of the ball surface and interacting with the holes and internal features around the holes may result in minimal differences in performance when compared to a standard ball.

In some examples, the features may form structures that together have larger dimensions. For example, a rib may be formed in a spiral that spans the entire inside surface of the ball. Such a feature may have a greater ability to transfer energy into the air space within the ball in some examples. Similarly, a recessed feature may have a longer distance. In some examples, the dimensions and material choices for these feature may be used in designs that target frequencies of the fundamental modes of the balls as have been described.

In some examples, recesses may be designed for the purpose of changing the relative strength of regions of the ball surface. In some examples, a thin wall of a ball near a hole in the surface may inherently be more compliant due to the loss of some material. Accordingly, the regions between the adjacent holes (which may be considered plates of a form) may have thickness variation.

Referring now to FIG. 2B, a damping material 202 may be coated upon the interior surface of a pickle ball. The damping material may be sufficiently flexible so as to transfer the sound energy from the external shell, while providing a damping action. In some examples, such a damping material 202 layer may reduce efficiency of transfer of energy through the interior 122 of the ball. In some examples, the damping material may also act upon the vibrations that transfer around the spheroid surface 121. In some examples, the damping layer may be coated upon features of the other embodiments as discussed. Some exemplary materials for a damping material may include rubbers, silicone layers, Styrofoam, foam, or other materials that will adhere upon the solid shell and provide a damping action. There may be coating layers upon the sphere surface to ensure a significant bonding between the outer shell and the damping layer. The dimensions of the outer shell, such as its thickness, may be modified such that a ball with design meets size and weight specifications. The various coating layers and structures may have irregular shapes and location separations from each other in some examples. In other examples, they may have regular shapes and regular separations from each other. In some examples, the various coatings and features such as rigs, tabs, cavities and trenches may act in such a manner that they may mitigate sound response of a pickleball while still not altering the elastic/bouncing action/response of the ball or at least having a small amount of difference from a standard ball for performance, bounce, response, interaction with paddles and the like. Accordingly, in some examples a way of thinking about the techniques and apparatus to lower the intensity of a sound emanation or to shift a frequency of a sound emanation of a pickleball is that the changes do not take energy from a motion of the pickleball when it is struck by a paddle, rather as much as possible they convert vibrational energy to forms of loss from that vibrational energy other than sound, such as heat within the features and layers that are formed. As well, energy in a ball may drive the ball structure to achieve a resonance of vibrational energy within the ball that ultimate emanates from the ball as sound at roughly those frequencies, accordingly, changes in the resonance properties of the ball structure may adjust the sound frequency that does emanate.

Referring now to FIG. 2C, a different type of coating may be applied to the inside of the pickleball. An aerogel layer 203 may be utilized. An aerogel layer 203 may be a very low density layer that includes many trapped gas bubbles. In some examples, other materials than aerogels which have significant damping properties may be used such as foams, open cell foams and the like as non-limiting examples. The structure of the aerogel layer 203 can act to reduce sound by trapping sound vibrations within the bubbles and turning them into heat energy. The manufacturing process, some of which are described in following sections herein, may provide a thick layer of the aerogel layer 203 while maintaining a large interior 205 and hole paths 204 on the interior of the pickleball to better allow air flow through the holes to be close to matching a standard pickleball. In some examples, the interior of the pickleball may not have the holes and cavity all through the interior and may have no hole structure or small recesses from the surface of the pickleball in the regions of holes in the outside surface layer to provide some ability for air flowing over the pickleball to change pressure at the hole locations and cause turbulence.

In some examples, the characteristics of damping layers and aerogels may be picked such that the acoustic impedance of the layer is lower compared to that of the rest of the solid shell. In cases of lower acoustic impedance, as sound transfers from the solid shell to the damping layer it may undergoes a phase shift of 180 degrees as it reflects from the layer. Such an effect may reduce acoustic sound emitted from a pickleball under some examples.

Although the aerogel layer can have the benefit of being very light, again the thickness of the outside solid shell layer 206 of the pickleball may be adjusted so that with any weight of the aerogel layer 203 the total ball weight may be consistent with a specification of a standard pickleball. The aerogel layer 203 may have inherent sound damping characteristics. Aerogel layers may include inorganic aerogels such as silica aerogels, polymeric aerogels such as polyurea, polyurethane, polyimide, and polyamide aerogels and complex versions of these such as including additives such as graphene oxide as non-limiting examples. Aerogel layers may include bio-aerogels based on chitosan and cellulose as non-limiting examples. Reference to various aerogel aspects may be made in reference to Acoustic Properties of Acrogels: Current Status and Prospects, Budtova et. al., Advanced Engineering Materials, Volume 25, Issue 6 the contents of which are incorporated herein by reference.

For example, the acoustic impedance of some exemplary solid shell materials may include ABS at 2.3-2.4MRayl, Polypropylene at 2.3-2.4 MRayl, High Density Polyethylene at 2.3 MRayl, Polycarbonate at 2.7MRayl, Nylon at 3.15 MRayl and Bakelite at 3.6M Rayl as non-limiting examples. Corresponding rubber type materials may include Silastic Rubbers at 1.16-1.2 MRayl, Polyurethanes at 1.6-2.0 MRayl, room temperature volcanizing (RTV) silicone polymers at 0.9-1.4 MRayl, and Syl Gard silicone polymers at 0.95-1.3 MRayl as non-limiting examples. Thus, a multilayered structure with these differing materials may create transitions in the acoustic impedance that sound would experience that may result in reflected waves shifted at 180 degrees of phase, again resulting in near destructive interference in the vicinity of the reflection. These various exemplary materials may be used in various combinations in manners as are described herein. Alternatively, layered structures where the acoustic impedance is graded may be used to induce vibrations in the outer shell to be conducted towards the inner surface of the ball and towards layers with more damping characteristics.

Referring now to FIG. 2D, the various examples of coating layers 210 on the inside of the pickleball including damping layers, xerogels, and aerogels may include a second solid shell layer 211 on the other surface of the coating layer. In some cases, a phase shift of the sound may occur as it passes and reflects from the external solid shell 206 to the coating layer 210. Here too, in some examples, the internal second solid shell layer 211 may also include cut outs where holes 212 occur in the pickleball as a whole. The inclusion of a second solid shell layer may receive sound from the coating layer 210 without undergoing another phase shift. Accordingly, sound emitted by the second solid shell layer 211 may emit sound from a close distance to the outer shell which, with the phase shift, may result in cancelling at least some of the noise from the ball. As in previous examples, the thicknesses of the various layers may be chosen to result in a ball that meets weight and other specifications on the ball. In some cases, the damping layer may dissipate the sound energy significantly before it has a chance to emerge into the inner space 205 of the ball without aspects of phase shifting. In some exemplary structures, which may be located around the holes may support the inner sphere to the outer sphere-which may improve structural strength but may give some vibrational pathways to avoid the damping material.

In another example, proceeding to FIG. 2E, a composite structure, similar to examples of the form of FIG. 2D may be formed where a different outer layer 221 may be formed where plates of the surface may be isolated from each other by cutouts 220. In some examples, the damping layers may be located inside the cutouts 220 as well. The result will be that conduction of sound vibrations around the outer surface of the spheroid 121 may be significantly damped by the isolation of plates. When an excitation occurs with striking of the ball and creation of vibrations 120 in the outer shell these vibrations may be significantly maintained within the plate or plates they are formed in. The result may be a shifted intensity of sound emitted as well as a shifting of frequency. In some examples, the plates may be held together between the two solid shell layers by a damping material with adhesive characteristics. The damping material may as well have acoustic absorption as well as phase shifting characteristics. As in previous examples, other coatings, tabs, and ribs internally located within the second plate may be employed.

Referring now to FIG. 2F, active elements 232 may be employed for noise reduction. Active elements may use power sources such as batteries 230 to power electronics and energy transducers. The electronics may sense vibrations within the ball interior and shell. The electronics may calculate an appropriate offset vibration that when added to the natural vibrations may cancel them out. There may be various transducers 231 such as piezo-electronics, magnetic elements such as linear resonant actuators, eccentric rotating mass actuators, dielectric elastomer actuators, standard magnetic membrane speakers and the like. Thin film batteries and thin film actuators may be dispersed across an inner surface of the ball along with electronic elements that may measure vibrations, apply vibrational cancellation algorithms, and actuate transducers. In some examples, the battery elements may be rechargeable. These elements may be placed such as to maintain a symmetry within the ball so that it may act as a normal ball under the action of gravity and wind forces. In examples where plates are isolated, as have been described in relation to FIG. 2E there may be a set of power elements, electronics, and actuators for each plate.

Referring now to FIG. 2G, a ball may be formed of a series of thin layers 240 that may be supported by structure 241 to act to isolate sound vibrations from one zone defined by a thin solid shell layer to another. In some examples some of the intervening spaces may be filled with aerogels, foams, or other such damping materials to aid in the absorption of sound energy. Furthermore, the layered structure may change the resonance characteristics of the space within the interior of the ball structure. In some examples, holes 204 may penetrate just the outermost layer. In some other examples, the holes may penetrate one, some or all the internal thin layers.

Referring now to FIG. 2H, a ball may be formed with one or more of the various aspects as have been described in the examples of the present disclosure but where details of the holes are also part of the innovative design aspects. As is described in some of the following experimental sections, data from experiments may demonstrate important aspects of noise generation that may involve the holes. Utilizing the measurement techniques as have been described it may be possible to measure particular ball constructs for sound emission while varying aspects of the holes 204. In a simple case, the number of holes 204 may be varied. In some examples, sizes of holes may be varied and may include different hole diameters 243. In some examples, the actual area of all the holes that communicate with the internal space of the ball may be adjusted in these manners. In an example, the thinning 242 of regions of a ball may be one of the variations that a particular ball design has. The ball design may be subjected to experiments that vary the number, shape, or size of holes to determine when the ball generates the least amount of energy. In some examples, the least amount of energy may be limited to the region of roughly 2-5 kHz mentioned previously as the most sensitive for human hearing. For one particular design of ball material, thickness, presence of additional features or layers it may be tested that ⅔ of the opening area of a standard ball solution may result in the lowest sound. In other experiments of how balls with this minimized condition perform in sports playing conditions. It may be true that all balls should have size or shape changes or that a subset of the balls maintain a more standard shape and diameter but some of the holes are altered. In an example a standard ball design with 40 holes made of high density polyethylene HDPE may be redesigned according to this method to have only 30 holes of the standard design for example.

Referring now to FIG. 2I, the shapes of hole features may also be altered for measured sound performance. In FIG. 2I a cross section of an exemplary hole is illustrated with side walls 250 that form a frustrum tube in three dimensions with inward projection. In some examples, this shape may be used for the standard thickness of the sphere wall itself. In some other examples, ball material may be formed to create features that protrude within the inner space of the ball. In some of these examples, such hole features may effectively change the “effective area” of the hole in the previous discussion of reaching a particular area of open space in the holes. The frustrum tube shape may cause further modifications to the sound characteristics of the ball, especially modes of sound related to the emanation from within the ball. It may be understood that the angle of the frustrum tube walls and thickness of the hole walls when they project past the ball wall may be varied to create different acoustic effects.

Proceeding to FIG. 2J an alternative sidewall of the holes design is illustrated where the sidewalls 251 once again may form a frustrum tube but in this case with outward projection. Unlike the case in FIG. 2I the effective area of such a design may not change from a standard hole due to the shape. In some cases, sound may reflect along the frustrum tube. As before, the length of the sidewall may traverse the ball thickness in some examples. In other examples, the walls may protrude within the sphere. It may be understood that the angle of the frustrum tube walls and thicknesses of the hole walls when they project past the ball wall may be varied to create different acoustic effects.

Proceeding to FIG. 2K, an alternative sidewall of the holes design is illustrated where the sidewalls 252 may not be linear and thus may form a complicated frustrum tube shape. As in the case in FIG. 2I, the effective area of such a design may change from a standard hole due to the shape. In some cases, sound may reflect along the frustrum tube. As before, the length of the sidewall may traverse the ball thickness in some examples. In other examples, the walls may protrude within the sphere. It may be understood that the complex shape of the frustrum tube walls and thicknesses of the hole walls when they project past the ball wall may be varied to create different acoustic effects.

In some examples, some or all of the holes in the ball may not be open. In one example such as with the sidewalls of inner projection related to FIG. 2I as a non-limiting example, the end of the hoe may be covered with a diaphragm 254. In some examples the diaphragm may be a solid of the ball material, where the cap may serve to limit airflow through the hole alone. In some other examples, the diaphragm may be an elastomeric material such that the diaphragm may vibrate at certain frequencies. In some examples, the diaphragm may be located at an inner projection of the sidewall. In other examples, it may protrude from just below the surface of the ball covering the hole beneath a surface of the ball. In some examples, such a diaphragm may be able to dissipate sound and vibrational energy. In other examples, it may be used to transmit sound of certain frequencies. In some examples, the materials of such covers may exhibit non-linear aspects that may allow frequency mode coupling for example in reaching frequencies that are transmitted. In some examples, the diaphragm may both dissipate energy while also transmitting energy. In some examples, the diaphragm may be formed of a flexible, lightweight design which may favor transmission. In other examples, the diaphragm may be formed of dense, rigid, or highly damped materials and designs which may favor dissipation.

Referring now to FIG. 2M, in some examples, all or many of the holes of a ball design may have one or more sidewall shapes and may be capped in certain ways. In some examples, the capping of different shaped holes such as 204 and 243 may have elastic diaphragm covers. In other examples, they may all be molded as caps of the ball material type. In still further examples, some of the caps may be made of ball material and some diaphragm material. In some examples, a ball may have a standard hole pattern while having one or more such holes having a cap or a diaphragm depending on measurements of the sound absorbance minimization. In some balls with holes, such as a pickleball, a purpose of the hole pattern may interact with an air stream that forms around the ball as it moves in the air.

Referring now to FIG. 2N, in some examples, an entire volume of a ball may be filled with an alternative damping material. In some examples, the inner region of the ball 260 may be filled with one or more layers. In some examples, one or more of aerogels, open cell foams, elastomers and the like may be employed to fill the space with relatively light weight structure that may be able to survive the stresses of play in games utilizing the balls. Since the acoustic impedance of the interior layers are much closer to materials that may be used to fabricate the shells of such balls, the ability to transfer vibrational energy across the interior 260 region may improve. If the materials are absorptive and damping materials, then the energy may be dissipated significantly within the interior of the ball. Multiple layers may be used to improve the transfer of energy into the damping regions.

Referring now to FIG. 2O, a combination of various aspects may be made for types of ball design. In some examples, the inner surface may be configured with isolated rib structures 261 configured of a material such as in non-limiting example polyurethane with some degree of flexibility (in a non-limiting example of a material of hardness Shore 20A-40A) with a dimension of roughly 2 mm by 2 mm at the base. The height of the features may be designed so that the resonant frequencies of the structures match up with inherent resonant frequencies of the ball design. In the following table are some examples of heights for different height and width dimensions. The ball may be fabricated by depositing features upon a ball form of these dimensions. Or, alternatively, a ball form may be deposited up these features. A list of exemplary estimated values for the height of square based structures that protrude from the inner surface is depicted in the following table. In some examples, variation of these dimensions are experimented upon for the lowest observed sound output.

| w = l (mm) | Frequency (Hz) | Height h (mm) |
|---|---|---|
| 1.0 | 2600 | 0.20 |
| 1.0 | 8000 | 0.60 |
| 2.0 | 2600 | 0.78 |
| 2.0 | 8000 | 2.41 |
| 3.0 | 2600 | 1.76 |
| 3.0 | 8000 | 5.43 |

In a different version of designs, all the features may be kept at the same height and the widths and lengths of the protruding features may change. In an example summarized in the table below, the protruding ribs may be formed of silicone. In the following table the width and length of features that would result in resonance at selected frequencies of interest are displayed for the case where the silicone features protrude 5 mm from the surface as a non-limiting example.

Resonant Frequency for 5 mm

| Frequency | Width = Length |
|---|---|
| (Hz) | (mm) |
| 1800 | 2.5 |
| 2400 | 2.2 |
| 2600 | 2.1 |
| 8800 | 1.1 |

If a ball had one hundred ribs of each type on its inner surface the weight may be estimated at about 8 grams.

Referring now to FIG. 2P, the combination of the type illustrated in FIG. 2O may be further refined by the addition of a damping layer 262. As energy flows from the outer shell into the different rib structure, the energy of the desired frequencies may be drawn into the rib structures which may accordingly vibrate at those frequencies. By adding a damping layer, these vibrational motions may be dampened with a dissipation of the energy involved. The presence of the layer may be expected to alter the dimensions required for resonances at desired frequencies. Other types of damping layers may be used including aerogels, and elastomeric films as non-limiting examples. In some examples, as mentioned above a given height of the rib like features may be maintained across features targeted for different resonant frequency ranges in these cases the width and length may be varied to obtain features that would resonate at different targeted frequency ranges.

A method for making a ball with a particular design may accordingly involve designing a ball with certain shell characteristics, holes and the like and determining the resonant frequencies of such a ball either with empirical models or by fabricating the ball and performing measurements as described. The method may continue with a designs of rib features to be formed upon the inner surface of the ball to provide a resonant energy dissipation features at the resonant modes of both the shell and the inner space of the hollow ball structure. This method is related to the specific examples of FIGS. 2O and 2P, from a more general perspective methods of productions of the various examples follows.

### Methods

There may be numerous methods that may be used to create the sports related apparatus disclosed herein. In a first set of examples molds may be created to form the sports related apparatus. In some specific examples the sports related apparatus may include a sports ball and more specifically a sports ball for the sport pickleball. Molds may be used with a variety of techniques to form the ball structure. In some examples, injection molding of plastics or other polymers may be utilized to form the ball structure. In some examples, vacuum infusion molding may be used to draw resins or other starting mixtures into the mold to form the desired shapes. In some other examples, rotational casting of a resin into the mold may be used to coat the mold surfaces evenly to form the molded structure. In some examples, there may be a more complex structure of the ball, and a number of these processes may be combined to form a ball structure.

In another set of examples, the ball structure may be formed by additive manufacturing techniques where the structure may be built in layers. One or more of material extrusion, sheet lamination, binder jetting, material jetting, directed energy deposition, powder bed fusion, vat photopolymerization, and stereolithography may be examples of additive manufacturing techniques that may be employed in some cases. The additive manufacturing may include multiple material processing for more complex structures. In some examples, a combination of an additive manufacturing process with prior or subsequent molding processing steps may be employed.

Mechanical processing and machining may be used to form some features of a sports apparatus as described herein. In some examples, a spherical sports ball structure may be defined by other techniques such as molding and additive manufacturing or a combination of them and machining may be used to cut holes into the structure. In some other examples, a surface texture may be formed by mechanical processing including milling, sanding, polishing and the like. In some examples, directed energy devices such as laser cutters and laser annealing may be used to cut surfaces and to anneal surfaces. Since a ball structure includes holes in the outside layers of the ball, such holes may function to support holding a ball device during a mechanical processing step.

Coating processes may be employed to form layers within a ball structure or to aid in defining an acceptable outside shell. In some examples, one or more coating process steps may include dip coating, brush coating, roll coating, spray coating, spin coating, and flow coating as non-limiting examples. Since a ball structure includes holes in the outside layers of the ball, such holes may function to support holding a ball device during a coating processing step.

Thermal curing processing steps may be employed after layers are formed in the ball structure. These steps may include oven/furnace processing which may be performed under various ambient environments including inert gases and vacuum.

In some examples, thermoforming may be used to define various elements of the ball. In some examples a spherical shaped starting structure may be rapidly brought to its thermal transition point and inflation may expand the sphere against a mold to form molded features. In some examples, a method of using an apparatus for the reduction of a sound level produced during a sporting activity may be performed. The method may include obtaining an apparatus used in the sporting activity, wherein the apparatus used in the sporting activity is configured to reduce a sound level produced during the sporting activity. This apparatus may include a first approximately spherical shell, wherein the first, approximately, spherical shell comprises an outer surface without topographic features sticking out more than 0.1 mm from the local surface. The apparatus may also include a plurality of holes penetrating through the spherical shell and located across the spherical shell. And the apparatus may include a plurality of surface features upon an inner surface of the approximately spherical shell, wherein the inner surface is distally located from the outer surface in a direction towards a central point of the spherical shell. And the method may include striking the apparatus used in the sporting activity with a paddle.

In some examples, a method of forming an apparatus for the reduction of a sound level produced during a sporting activity may include creating a first concave shaped molding surface to mold an exterior surface of at least a portion of a sports ball used in the sporting activity. The method may also include creating a first convex shaped molding surface to mold an interior surface of at least a portion of a sports ball used in the sporting activity, wherein the first convex shaped molding surface comprises surface features to mold features upon the interior surface of at least a portion of the sports ball. In some examples, the method may also include examples wherein the surface features of the first convex shaped molding surface define one or more of tabs, ribs, trenches, or wells on the inner surface of the sports ball. In some examples, the method may also include examples wherein the portion of a sports ball is a hemisphere. And some of these examples may include examples wherein the mold surfaces are combined to create a half sphere of the ball structure. The method may also include examples wherein two of the half sphere structures are joined together to form a ball. In some examples, the method may further include combining the first convex shaped molding surface and the first concave shaped molding surface to form an assembled mold to form at least a portion of a ball surface; and forcing a ball forming material into the assembled mold. In some examples, the method may also include examples further including combining the first convex shaped molding surface and the first concave shaped molding surface to form an assembled mold to form at least a portion of a sports ball surface. The method may include filling a ball forming resin into a sprue of the assembled mold. And the method may include rotating the mold to rotationally cast the at least a portion of the sports ball surface. In some examples, the method may further include examples wherein the first mold comprises tab features to define holes in the surface of the sports ball.

In some examples, a method of forming an apparatus for the reduction of a sound level produced during a sporting activity may include creating a first concave shaped molding surface to mold an exterior surface of at least a portion of a sports ball used in the sporting activity. The method may further include creating a second concave shaped molding surface to mold an exterior surface of at least a portion of a sports ball used in the sporting activity. The method may further include creating a third concave shaped molding surface to mold an insert piece to be positioned within an assembly comprising at least the first concaved shaped molding surface and the second concave shaped molding surface, wherein the insert piece formed by molding with the third concave shaped molding surface has a negative shape for a surface feature to be formed upon an inner surface of the sports ball. The method may further include utilizing the third concave shaped molding surface to form the insert piece. The method may further include assembling a first molding assembly comprising at least the first concave shaped molding surface and the second concave shaped molding surface around the insert piece such that a molding cavity is formed between the insert piece and the other molding surfaces. And the method may further include using the first molding assembly to perform a molding process to create a sports ball. In some examples, the method may further include examples wherein the insert piece is formed of a material that will dissolve in a first solvent that does not dissolve the sports ball. This method may further include placing the result of using the first molding assembly to perform the molding process into the first solvent. In some of these examples, the first solvent may be water. In some examples, the method may include examples wherein the molding process on the first molding assembly involves rotationally casting a resin in the first molding assembly. In some examples, the method may include examples wherein the insert piece defines the interior surface of at least a portion of a sports ball used in the sporting activity, and wherein a surface of the insert piece comprises surface features to mold features upon the interior surface of at least a portion of the sports ball. In some of these examples, the method may include examples wherein the first mold comprises tab features to define holes in the surface of the sports ball.

In some examples there may be methods of using an apparatus to reduce a sound level produced in a sporting activity including forming the apparatus to reduce a sound level. This apparatus may include a first approximately spherical shell, wherein the first, approximately, spherical shell comprises an outer surface without topographic features sticking out more than 0.1 mm from the local surface. The apparatus may further include a plurality of holes penetrating through the spherical shell and located across the spherical shell. And the apparatus may further include a plurality of surface features upon an inner surface of the approximately spherical shell, wherein the inner surface is distally located from the outer surface in a direction towards a central point of the spherical shell. In some of these examples to form an apparatus to reduce a sound level, the method may include the steps of creating a first concave shaped molding surface to mold an exterior surface of at least a portion of a sports ball used in the sporting activity. The method may further include creating a second concave shaped molding surface to mold an exterior surface of at least a portion of a sports ball used in the sporting activity. The method may further include creating a third concave shaped molding surface to mold an insert piece to be positioned within an assembly comprising at least the first concaved shaped molding surface and the second concave shaped molding surface, wherein the insert piece formed by molding with the third concave shaped molding surface has a negative shape for a surface feature to be formed upon an inner surface of the sports ball. In some examples, the method may include utilizing the third concave shaped molding surface to form the insert piece. The method may further include assembling a first molding assembly comprising at least the first concave shaped molding surface and the second concave shaped molding surface around the insert piece such that a molding cavity is formed between the insert piece and the other molding surfaces. In some examples, the method may further include using the first molding assembly to perform a molding process to create a sports ball. And the method may include striking the apparatus used in the sporting activity with a paddle.

In some examples, a method may involve creating ball halves by methods that have been described and then joining the halves together. In some examples, halves may be glued together or joined with solvent melting of the surfaces. In some other examples, mating surfaces may be melted together by exposure to heat, heated air, photon irradiation such as by a laser or focused light source, or ultrasonic melting.

In some examples a ball may be formed in halves and then joined, or it may be formed as a whole sphere, such as through rotational molding. Subsequently the ball may have a pattern of holes drilled into the body by mechanical means or by other cutting methods such as laser cutting and high pressure water cutting as non-limiting examples.

### Feature Creation by Branding and Laser or Light Processing

Branding strategies for sports balls may include various heating methods to create distinct patterns or features on the ball's inner surface. One method may involve iron electrical heating, where an electrically heated iron tool applies heat to the ball's surface, creating a branded mark. This method may allow for precise control over the temperature and pressure applied, ensuring consistent and durable branding. Another method utilizes gas burning, where a gas flame heats a branding tool that then contacts the ball's surface. This technique may achieve deeper and more pronounced marks, suitable for materials that require higher temperatures for effective branding. Optical or laser heating may also be employed, using focused light to heat specific areas of the ball's surface. This method offers high precision and may create intricate and detailed patterns without physical contact, reducing the risk of material deformation. In some examples, additive processes may involve the use of optical or laser heating to define ribs or raised features upon the inner surface of the ball. In these cases, the laser light may be used to initiate a polymerization reaction for example.

Internal branding in a pattern may involve tooling that imprints a design on the interior surface of the ball. This may be achieved through various methods, including the use of molds with pre-formed patterns or the application of heat and pressure to transfer a design onto the internal surface. The tooling may be designed to withstand the manufacturing process and ensure that the pattern is as designed to reside on the inner surface of a ball.

Hot wire cutting is another technique which may be used in the branding process. This method may involves using a heated wire to cut through a portion of the ball's inner surface. The hot wire may be precisely controlled to cut at specific depths and angles, allowing for the creation of complex designs. This technique may be particularly useful for materials that respond well to thermal cutting and can produce clean, sharp edges on the branded pattern.

A heated cylinder with a point may be manipulated to erode material from desired locations. In some examples, a half ball may be processed where easy access to the inner surface may result. In other examples, the heated cylinder may be alternatively manipulated through different holes in the balls surface to gain access to the interior of a spherical ball piece. Again, an additive process may utilize the described techniques. A hot point, laser or focused light source may be used to create features on a ball's inner surface. In a stereolithography process, reactive chemical monomer may fill from the bottom of the balls inner surface while tooling controls the location of the hot point, laser or focused light source to initiate polymerization of the polymer locally to the point of focus. As the monomer is filled, features may be added to the ball's surface. In some examples, optical fibers which are small enough to be brought through holes in a complete spherical ball may be used to perform this process on whole balls as well. In some examples, lithographic techniques may be used to delineate patterns at the edge of the balls' surface. For example, a DMD type imaging device may be used with a light source to quickly scan patterns on the surface of reactive monomer mixtures to create features upon ball surfaces.

In some examples, the stereolithographic processing may be used to create balls with interior features in a single step, where the features and the ball material are the same. In some examples, the stereolithographic processing may create an insert that may reside inside a sphere ball outer structure. In a non-limiting example, a silicone or other flexible material may be formed with inner rib, trench, or other such features and then adhesives may be used to adhere two high density polyethylene outer shells to the inner flexible material. In some other examples, a ball may be assembled with plates that are glued into place on the formed inner sphere construct (an example describes this plate design and process in more detail in a following section.)

### Rotational Molding

Rotational molding involves a process where a mold containing a polymer material rotates along two perpendicular axes, ensuring even distribution of the material to form a hollow object. The mold may be formed from two pieces which are made from materials that will not adhere to the polymer material that is introduced during the rotation process. In some examples, surface release formulations may be applied to the molding pieces to ensure that after polymerization is complete and the two mold halves are separated that the molded piece may be separated. The polymer material may be a specialized formulation with characteristics that support the rotational molding process such as having a long period of gelation, so that the monomer and polymerizing components may flow evenly across all surfaces of the mold parts. The mold parts may have features (in negative to the surface of the molded part) and depending on their height (extent) may define openings (such as holes) in the molded part. In some examples, a hollow sphere without any features may be formed in this manner and holes may be cut into it after it completes polymerization.

This technique may be employed to create sports balls with multilayered structures and internal features. In some examples, the process may begin with the formation of skin pieces, which are multilayered components that include internal molding features. These skin pieces may be created by sequentially adding layers of material within the mold, ensuring that each layer adheres to the previous one, resulting in a cohesive and robust structure.

In another example, multilayered structures may be achieved by drilling holes through the initial layers and subsequently adding additional layers through these holes. This method ensures that the internal features are securely integrated into the overall structure of the sports ball. The drilled holes allow for precise placement of materials, which can enhance the ball's acoustic properties by incorporating sound-damping elements within the internal layers.

Internal features, such as damping tabs, ribs, or other irregularities, can be molded directly into the ball during the rotational molding process. These features may be designed to scatter vibrations, vibrate at resonant frequencies, and generally reduce sound emissions when the ball is struck. The internal features may be formed of various materials, including plastics, elastomers, composites, or other types of polymers depending on the desired acoustic and mechanical properties.

In some examples, a molded internal piece may act as a subsequent molding surface for an external coating within a mold of this type. This internal piece can be designed to include specific features that will be transferred to the external surface of the ball during the molding process. The internal piece may be initially formed without drilling holes, ensuring a smooth and continuous surface for the external coating. This method may allow for the creation of complex internal geometries that contribute to the ball's overall performance and sound characteristics.

In a variation similar to rotational molding but not the same, the external coating may be applied by spray coating of the internal structure. In this situation, the spray head may rotate around the object being coated and/or the object being coated may rotate in space while the spraying process occurs.

### Injection Molding

In some examples, exemplary balls according to the present disclosure may be formed by injection molding in two halves. Two separate molds may be used to create the two hemispherical halves of the pickleball. Each mold may produce one half of the ball including some of the common design features such as ribs and the like. In some examples, the mold may produce a perforated design where the holes are formed with the ball body. In the injection molding process, thermopolymeric material (such as polypropylene or polyethylene) may be melted and pressurized to be injected into the molds described to form the hemispheres. The molded parts are allowed to cool and are then ejected from the molds.

In a specific non-limiting example, two half balls along with hole features may have a temperature sensitive adhesive sprayed upon their inner surface. An inner component, such as a thin hemisphere comprising flexible polyurethane ridges as have been described here may also have a temperature sensitive adhesive sprayed upon their outer surface. The two pieces may be aligned in a press and heated along with pressure to join the parts. In a following discussion, methods to join two hemispheres are described.

In some examples, plates that may be used to assemble a ball that has isolated portions of the relatively hard outer shell may be formed by injection molding. In some examples the plates may be molded in a mold whose overall shape is that of a half ball. (In the case of a geodesic ball design similar to a soccer ball described in following sections there may be no straight line hemisphere lines so a “half” may have features which overlap a hemisphere). In some cases where plates are injection molded, small connection elements may generally hold the plates to a desired form, with a fixed interface between the molded plates.

In a specific example a collection of plates with small connection elements that comprises one “half” of a ball may be coated with an adhesive such as a silicone adhesive. An internal piece which may have ridges, and the like formed in a silicone material may also be coated on the outside with a silicone adhesive. The two parts may be aligned in a jig that may apply pressure and venting or vacuum capability may be used to hold the two parts together while the adhesive firmly attaches the parts. The two “halves” may be joined in following steps.

In either of the cases mentioned above in the injection process, thermopolymeric material (such as polypropylene or polyethylene, other thermoplastics, and thermosets) may be melted and pressurized to be injected into the molds described to form the hemispheres. The molded parts are allowed to cool and are then ejected from the molds.

In some examples, the edges of the two halves may be designed with a tongue-and-groove or lap joint to facilitate precise alignment during a joining process, In some examples, the two halves may be aligned and joined together using one of the following methods. In some examples, ultrasonic welding where high frequency vibrations generate localized heat to melt and fuse the edges together and create a seamless bond. In some examples, heat welding may be employed where the edges are melted using a heated tool or laser and pressed together until they solidify. And, in some cases adhesive bonding may be employed where a strong adhesive may be applied to the edges to join them. Excess material from any of these joining processes if there is any may be trimmed or polished for a clean finish. These techniques may achieve a quality joint which may last during play and as a result of molding the two halves individually there may be better control on such things as a consistent wall thickness and quality of features added. The processing may also be more efficient for production purposes.

### Materials

There may be various materials that may be used to mold, inject, or print ball/sphere shells. Commercial compositions may be obtained to be tailored for particular needs such as in a non-limiting example a variety of materials from Smooth-On Inc., Macungie, PA.

In some examples as described herein, molding may be performed with silicone rubbers which may include tin-cure (condensation) and platinum-cure (addition) silicones. These silicone rubbers may have particular qualities of flexibility, durability, and excellent detail reproduction. In a non-limiting example, a monomer base of polydimethylsiloxane (PDMS) may include various cross linking compounds such as tetra orthosilicate (TEOS) and some formulations may include catalysts such as tin octoate or chloroplatinic acid.

In some of the examples a flexible portion of the ball body may also be formed of polyurethane rubbers which may be available in various hardness levels. In some examples formulations may include one or more polyols such as polyether polyols, polyester polyols, aromatic isocyanates, aliphatic isocyanates, chain extenders such as butanediols or ethylene glycol, catalysis, fillers, binders. Commercial compositions may be obtained to be tailored for particular needs such as in a non-limiting example a variety of materials from Smooth-On Inc., Macungie, PA.

A harder shell may also be molded of polyurethane polymers which may afford rigid and semi-rigid parts. Some formulations may improve impact resistance which may be important in the applications here. The general formulations may include similar components to polyurethane rubbers but formulated for a more rigid result including, polyols, isocyanates, chain extenders, catalysts, and various additives for UV resistance, color characteristics, impact resistance and the like.

The harder shell may also be cast or coated using epoxy resins. These formulations may include in a non-limiting sense epoxy resins such as bisphenol A-based resins, bisphenol F-based resins, and Novolac based resins. Formulations may also include curing agents such as amines, anhydrides, polymercaptans, and phenolic hardeners. Formulations may include reactive diluents to adjust viscosity. Formulations may include plasticizers, fillers, toughening agents, colorants, UV stabilizers and the like. Epoxy resins may also be used for adhesive purposes when assembling multiple components into a ball.

In some examples, polyurethane foams may be used for some components of the balls described here. A polyurethane foam may include similar compositions as described for polyurethane rubbers, plastics and thermosets but also may include blowing agents which release gasses into the polymerizing matrix. The cured foams may range from flexible to rigid. The amount of the blowing agents released may create open cell or closed cell forms of the foams with the open cell foams resulting from ruptured pockets due to the gas release whereas the closed cell versions trap the gas within bubbles within the polymer matrix.

In other examples, a harder outer shell may be extruded in injection molding processes from various materials including in a non-limiting perspective polypropylene (PP), Polyethylene (PE) both high-density polyethylene (HDPE), and low-density polyethylene (LDPE), thermoplastic polyurethane (TPU), polycarbonate (PC), acrylonitrile butadiene styrene (ABS), nylon (polyamide, PA), polystyrene (PS), polyvinyl chloride (PVC), thermoplastic elastomers (TPEs), polylactic acid (PLA), and silicone rubbers.

In other examples, a harder outer shell may be extruded in 3D-Printing type operations. The material choices are varied and may include formulations, in a non-limiting sense, of polyethylene terephthalate glycol-modified (PETG), acrylonitrile butadiene styrene (ABS), nylon (polyamide, PA), and thermoplastic polyurethane (TPU). Softer materials may also be printed with materials the various forms of materials for 3D printing as well as injection molding where the filament composition is varied for a more flexible result.

In some examples, Stereolithography may be useful for the formation of hard outer shell components or more flexible interior components in some examples as described herein. Formulations such as available from Formlabs, Inc. of Sommerville, MA may be consistent with the processing disclosed herein. In some examples, a formulation may include, in a non-limiting sense, resins for a tough resin result including acrylates such as urethane acrylates, cross linkers such as TMPTA, or epoxy acrylates or bisphenol-A-based oligomers, and the like. For more flexible results elastomeric polyether or polyurethane acrylates may be included. Compositions may include crosslinking agents, photo-initiators, oligomers, fillers, plasticizers, coloring agents, UV stabilizers, impact modifiers, and the like.

In some of these examples, a basic structure may be enhanced by the incorporation of fiber reinforcement upon the body. In some examples, a more lightweight shell that may nevertheless be strong enough to withstand the aspects of game play may result from incorporation of such reinforcements. These reinforcements may be molded into the structure such as where a preform of the reinforcements is included in the mold before its use, or they may be added upon a formed structure (either halves or whole balls). The reinforcements may include carbon nanotubes, glass fibers, carbon fibers, aramid fibers, natural fibers, or inorganic fibers such as mineral fibers as non-limiting examples. High performance polymeric fibers such as nylon, polyethylene fibers, or polypropylene fibers may also be used. And hybrids or combinations of these various fiber examples may be used.

For electroactive examples, the materials may include additional examples that may be added into or upon the inner surfaces of balls. These additional materials may include semiconductor devices desirably of extremely small form factors that are able to utilize battery power from batteries such as solid state batteries which may be coated upon interior surfaces. Cathodes for batteries may include, in a non-limiting perspective, lithium nickel manganese cobalt oxide (NMC), lithium iron phosphate (LFP); and lithium cobalt oxide components. Anode materials may include graphite, silicon-graphite composites, lithium metal, or tin metal, or titanium based materials. Electrolytes may include liquid electrolytes such as solution of lithium salts in organic solvents, ceramic based lithium lanthanum zirconium oxide, polymer based such as polyethylene oxide with lithium sales, and Gel electrolytes such as polymer matrices infused with liquid electrolytes as non-limiting examples. Separators may include microporous polymers such as those based on polypropylene (PP) or polyethylene (PE). Separators may also include polymer-based coatings such as of ceramic-polymer composites. Separators may also include electrospun or printed layers of solid state electrolytes. The electroactive examples may include sound generating devices which may include piezoelectric transducers, membrane speakers, and electromagnetic coils as non-limiting examples. The electroactive examples may include sound sensing devices which may include piezoelectric transducers, microphones such as micro-electro-mechanical systems examples with diaphragms, microphones such as electret condenser microphones and resonant acoustic sensors as non-limiting examples. In some examples a system of a vibration detector, an IC, a sound generator, and a battery element may have multiple miniature elements distributed across the inner surface of the playing ball. In some examples, these miniature elements may be tuned to different frequencies and accordingly there may be different types included for ball designs with different resonant characteristics. In some examples, the electronic components may include one or more processors, memory elements, communication elements, power control elements, sensors for temperature, vibrations, pressure, and humidity, and input/output circuitry to control and receive. There may be components to receive charging for the battery elements in wireless or connected fashions. In some examples, the ICs may include noise cancelling aspects and algorithms and may include AI based training algorithms and/or resulting models to accommodate the sound environment of normal play and variations that may occur based on such factors as environment, temperature, humidity, playing surfaces and the like.

### Noise Minimization Strategies

Strategies to address sound reduction in sports balls, particularly pickleballs, involve understanding the hearing curve, sound transmission curves, and resonant modes of different ball designs. The hearing curve, which represents the sensitivity of human hearing across different frequencies, indicates that humans are more sensitive to selected frequencies, such as between 1 kHz and 5 kHz. Therefore, reducing these frequency components of the sound produced by a pickleball can significantly lower the perceived noise level. This may be achieved by designing the ball to emit sound at lower or higher frequencies, which may be less perceptible to the human car.

Sound transmission curves may describe how sound waves travel through different materials and structures. This may include how sound waves travel through air at standard temperatures, humidities and pressures or variations around these conditions. Generally speaking, the coefficient of absorption of sound may be expected to logarithmically increase with frequency. Accordingly, for examples where a change may be made which may shift frequencies of produced sound, it may be desirable to choose such changes with a preference to raising the frequencies that are generated to decrease the perceived-sound in the playing environs.

For example, features such as plates which are isolated from each other having absorptive material between the plates may have significantly higher resonant frequencies due to the smaller structure from which to generate sound. Accordingly, it may be possible to increase the frequencies emitted by balls which per se may improve the apparent noise observed in the environment surrounding playing surfaces such as for neighboring residences. In addition, such examples, including sound absorptive materials may also reduce the amount of energy emitted as sound of any frequency from the strikes to the ball surface inherent during play.

### Experimental Results

Numerous experimental aspects have been included in the examples described in the previous sections of the disclosure. A number of other examples are summarized here.

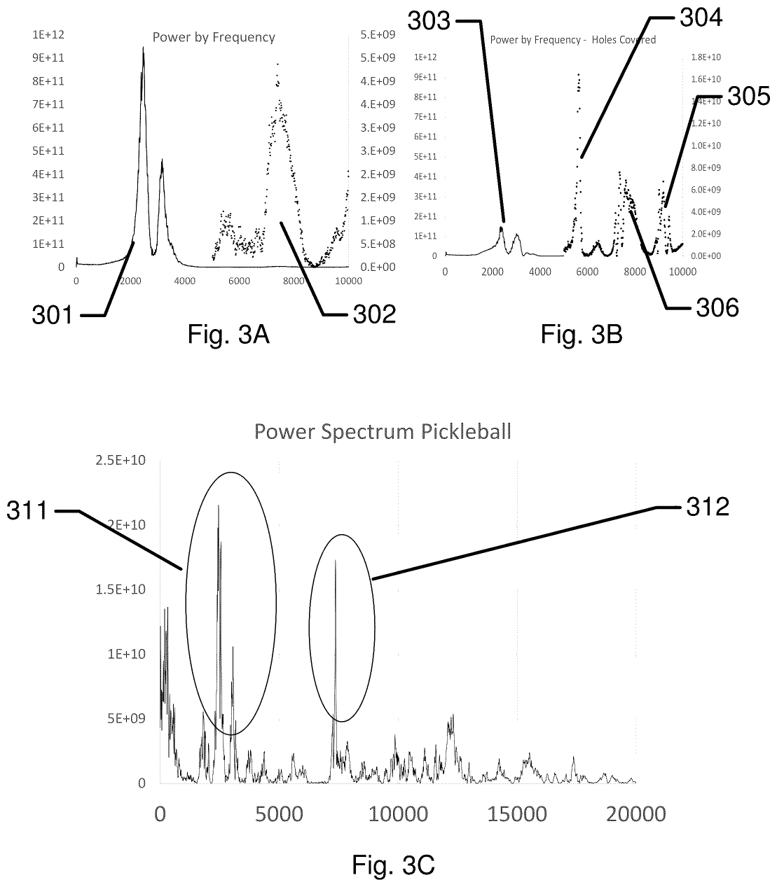

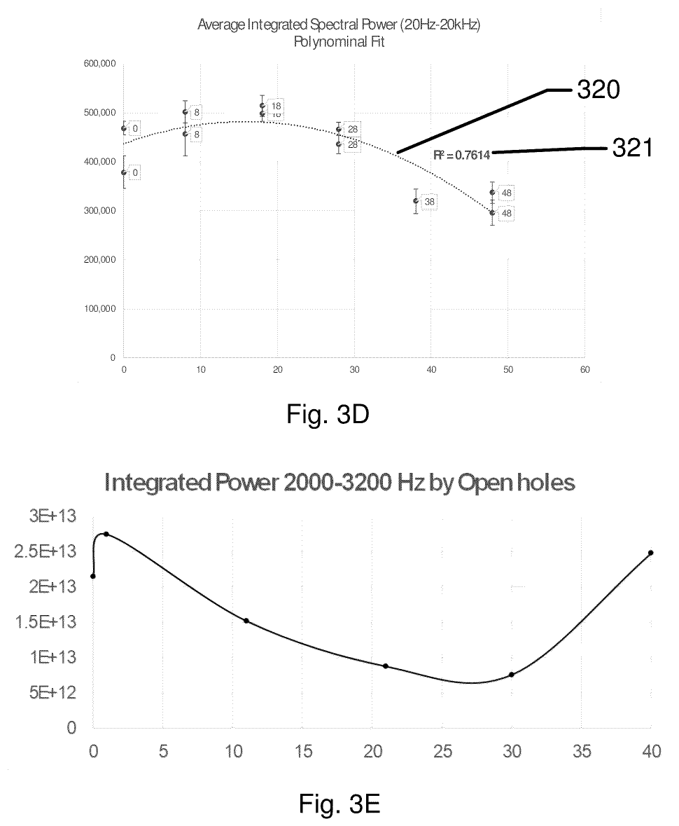

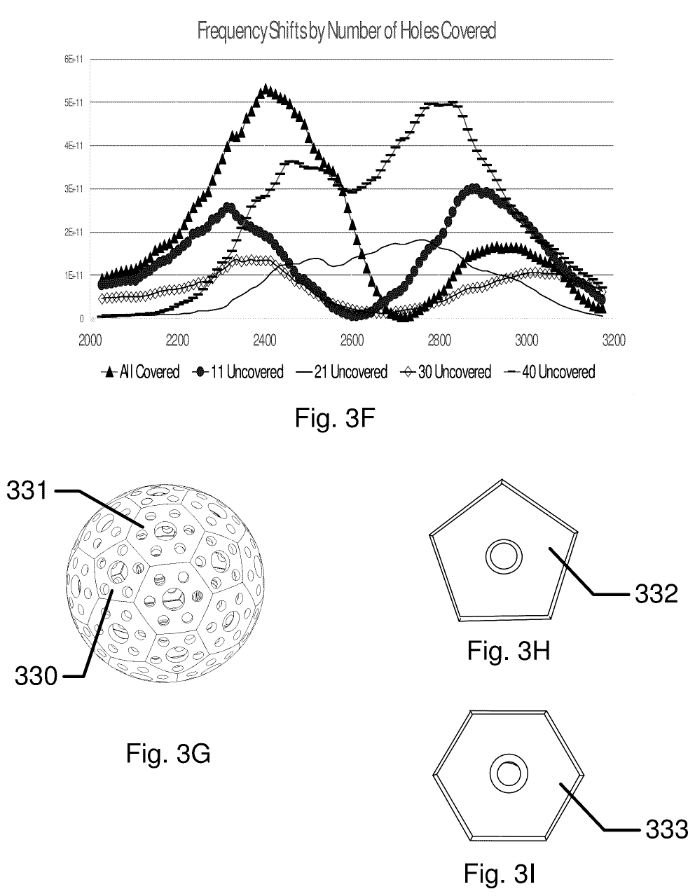

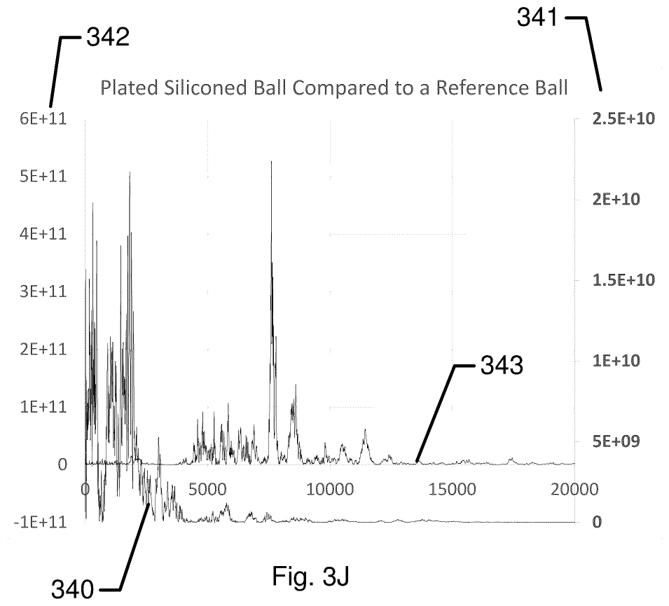

Referring now to FIGS. 3A and 3B an experiment is performed upon a relatively standard pickleball substrate, where the pickleball substrate is a 73 mm diameter hollow sphere formed of high density polyethylene with a wall thickness of about 1 mm. The sphere has 40 holes deployed across its body each of which is 7.3 mm of diameter with vertical sidewalls of each hole. A dropped steel ball experiment (0.25 inch diameter 6.35 mm) was performed. A Dayton Audio UMM-6 USB measurement microphone was used to detect the sound response and was located at a fixed ˜2 cm distance from the body of the ball under test. The pickleball substrate was held in place with a pair of rubber bands (Type 0419, Size 19, 3½× 1/16) each fed through two adjacent holes where the pair of holes for one rubber band is antipodal to the other pair of holes for the other rubber band. Estimates of the resonant frequency for the ball vibrating in this holding system may be expected to be approximately 30 Hz, and accordingly such low frequencies are not anticipated to have meaningful data. Referring specifically to FIG. 3A, sound measurements taken during the dropped steel ball experiment in the time domain were analyzed with a fast Fourier transform algorithm (standard fft function in Python version 3.12.4). A power of the signal versus frequency was calculated as the square of the fft amplitude for each frequency bin and the results plotted in the drawing of FIG. 3A and other related figures. In FIG. 3A, the resulting power amplitudes were plotted in two sets, one from 0-5 kHz and another from 5 kHz to 10 kHz where the second scale is magnified by approximately a factor of 200. What is observed are a dominant set of frequencies 301 at ˜2400 Hz. and ˜2600 Hz. An explanation of these frequencies may relate to coupled resonance modes between the air located within the ball and the effect of the holes which allow air outside the ball to be coupled. On the right side of the drawing of FIG. 3A, another dominant mode 302 at frequency ˜8000 is observed (again at levels roughly 200 times smaller than the left side data). An explanation of these frequencies may relate to the fundamental resonance modes of the shell of the pickleball.

Proceeding to FIG. 3B, the pickleball of the experiment displayed in FIG. 3A had 10 of its 40 holes covered with cellulose acetate tape with acrylic adhesive. A noted change in the noise produced by striking this ball construct in the experiment is observed. The left axis scale for the 0-5 kHz portion of the data (obtained in the same manner as described for FIG. 3A) is the same as in FIG. 3A. The magnitude of the dominant peaks 303 may be observed as roughly 1/10^{th} of the magnitude for the case of FIG. 3A for the ball without the cellulose acetate tape coverings. There are also two peaks 304 and 305 that emerge as the dominant peaks from 5 kHz to 10 kHz. It may be noted that these peaks are still significantly smaller in relative size to the features around 2400 Hz the dominant peaks 303. It may not appear that the emerged peaks 304, 305 result from a shift of the previously dominant peak around 8000 Hz since such a peak 306 is still observed at roughly the same magnitude. It may be apparent that a method of isolating holes by covering them with a diaphragm may be useful in forming balls with significantly reduced sound generation.

Proceeding to FIG. 3C, a result from a different type of experiment performed on the same type of ball used in the experiments of FIGS. 3A and 3B is illustrated. In this experiment, a 73 mm diameter sphere formed of high density polyethylene with a wall thickness about 1 mm. was used. The sphere has 40 holes deployed across its body each of which is 7.3 mm of diameter with vertical sidewalls of each hole. The sphere is subjected to a dropped ball experiment where the ball body is released from a height of ˜50 centimeters to a target zone of a concrete surface beneath. A Dayton Audio UMM-6 USB measurement microphone was used to detect the sound response and was located at a fixed ˜10 cm distance from the targeted impact location on the cement surface. The ball was released from a holding structure incorporating features to ensure the ball releases without any deflections as much as practical. High speed photography was used to determine that the ball hit near the target region. Due to the nature of the holes in the body of the ball, which may intentionally introduce some randomness to motion when the ball moves through the air, some dispersion in impact location as well as the introduction of some rotation into the ball during falling is observed. In the display, an exemplary result of dropping a ball under test in such a manner is illustrated. A sound amplitude signal was acquired from the microphone and processed as mentioned previously with respect to FIG. 3A. The resulting power amplitude vs frequency is illustrated in FIG. 3C for a full audible range from 1 Hz to 20 kHz. It may be noted that there are numerous peaks not observed in the dropped steel ball experimental type. Nevertheless, the dominant modes such as ˜2500 Hz 311 and ˜8000 Hz 312 are still present. It may be expected that the efficiency of exciting vibrational modes in the shell of the pickleball which are attributed to the peaks around 8000 Hz may be greater for interactions with a hard flat surface than with a steel ball. Furthermore, the coupling of the ball to the relatedly large mass of the concrete may be expected to define different coupling and different excitation of the ball during the relatively short time it collides with the surface which may explain the variety of lower amplitude features additionally observed. Using a combination of these experiments may allow for significant characterization of the characters of different tested balls and different ball embodiments as have been described herein. It may be noted that due to the nature of the difference in location of the microphone to the ball that direct comparison of amplitudes between the two experimental techniques may not be fruitful. However, relative values within different frequency ranges may be compared between to two techniques.

Referring now to FIG. 3D a branding experiment is illustrated. In the branding experiment a collection of balls was made to be processed in different cells with a branding tool. A hot iron with a copper spike was used to melt and create divots and ridges surrounding them. Depending on the ball in the experiment, some balls were undisturbed with the branding during the experiment and others received 8, 18, 28, 38 and 48 brands in different locations across the ball's interior surface. At 48 brands essentially each “plate” area between holes had a branding feature. The brands were made in two balls for each of the cells. The pickleball substrates which were branded were 73 mm diameter hollow spheres formed of high density polyethylene with a wall thickness about 1 mm. The sphere has 40 holes deployed across its body each of which is 7.3 mm of diameter with vertical sidewalls of each hole. A dropped steel ball experiment (0.25 inch diameter 6.35 mm) was performed. A Dayton Audio UMM-6 USB measurement microphone was used to detect the sound response and was located at a fixed ˜2 cm distance from the body of the ball under test. The pickleball substrate was held in place with a pair of rubber bands (Type 0419, Size 19, 3½× 1/16) each fed through two adjacent holes where the pair of holes for one rubber band is antipodal to the other pair of holes for the other rubber band. Estimates of the resonant frequency for the ball vibrating in this holding system may be expected to be approximately 30 Hz, and accordingly such low frequencies are not anticipated to have meaningful data. Referring specifically to FIG. 3A, sound measurements taken during the dropped steel ball experiment in the time domain were analyzed with a fast Fourier transform algorithm (standard fft function in Python version 3.12.4). A power of the signal versus frequency was calculated as the square of the fft amplitude for each frequency bin. Next the power signal was integrated for all frequency bins from 200 Hz to 20 kHz. Numerous ball drop experiments were performed for each of the branded balls. An average for the integration results was obtained for each condition and the statistical 95% confidence limit was also calculated. These results were plotted in the drawing of FIG. 3D for each of the balls. A polynomial line fit curve 320 was observed to have the highest regression fit measure 321. The polynomial line fit indicates an improvement of sound level as the ball is filled out with the branding features. Referring now to FIG. 3E the experiment disclosed with reference to FIG. 3B is completed for different numbers of holes covered by the cellulose tape. A pickleball substrate of a 73 mm diameter hollow sphere formed of high density polyethylene with a wall thickness about 1 mm was used. The sphere had 40 holes deployed across its body each of which is 7.3 mm of diameter with vertical sidewalls of each hole. A piece of cellulose acetate covered in acrylic adhesive was applied as a diaphragm over each of the 40 holes. A dropped steel ball experiment (0.25 inch diameter 6.35 mm) was performed with 40 holes covered with 39 holes covered, with 29 holes covered, with 19 holes covered, with 10 holes covered and with no holes covered. A Dayton Audio UMM-6 USB measurement microphone was used to detect the sound response and was located at a fixed ˜2 cm distance from the body of the ball under test. The pickleball substrate was held in place with a pair of rubber bands (Type 0419, Size 19, 3½× 1/16) each fed through two adjacent holes where the pair of holes for one rubber band is antipodal to the other pair of holes for the other rubber band. Estimates of the resonant frequency for the ball vibrating in this holding system may be expected to be approximately 30 Hz, and accordingly such low frequencies are not anticipated to have meaningful data. Sound measurements taken during the dropped steel ball experiment in the time domain were analyzed with a fast Fourier transform algorithm (standard fft function in Python version 3.12.4). A power of the signal versus frequency was calculated as the square of the fft amplitude for each frequency bin. The power amplitudes were summed across the frequency bins from 2000 Hz to 3000 Hz, which is the region related to air internal to the sphere and its interaction with the holes, and the results plotted in the drawing of FIG. 3D. A relatively surprising result of a significant minimum in the total amount of detected sound for the modes around ˜2500 Hz was observed to occur somewhere between 10 and 20 holes being covered with a cellulose acetate diaphragm. In the case of a standard pickleball design, this would correspond to designing a pickleball to have the amount of surface area open in the holes of the pickleball to be between 2.5% and 5% of the surface area of the combined pickleball sphere and the area of all the holes. It may be observed that improvement may still be afforded between 1% and 8% according to this metric. In some examples, the method may be more universally applied to different pickleball designs which may accordingly have different minimization values. The method may involve obtaining a pickleball object with a number of holes in the body. Covering all of the holes with a diaphragm or with a plug of substantially the same mass as the missing ball sphere material of a hole. Performing either or both of the ball drop test or the steel ball drop test upon the ball. Obtaining an integrated power amplitude figure of merit for integration around a region associated with resonance modes related to the holes. Determining an optimal area of holes based on a minimum sound emission from the ball. Designing a ball with either the same size holes and a number to achieve a closest result to the optimal area or designing a ball with a same number of holes where the hole size varies. Other results where the number of holes, area of holes and design of holes (such as with frustrum tube shaped holes) achieves the minimum result.

Proceeding to FIG. 3F another aspect of this example where holes are covered to assess optimal noise conditions is illustrated. Focusing on the frequency regime of modes expected to be related to the air of the inner portion of the sphere and its interactions with holes, the illustration indicates relative power figures of merit for the peaks from 2000 Hz to 3200 Hz as the number of covered holes is varied as described previously. What may be observed is that on either extreme (all holes covered, and no holes covered) the peaks around 2400 (dominant for all holes covered) and around 2800 (dominant for no holes covered) switch. In the optimal region with 10-20 holes covered it may be observed that both peaks decrease in intensity rather significantly.

The location of holes in the pickleball shell may also significantly influence the frequency and amplitude characteristics of the emitted sound. Accordingly, the method mentioned may be utilized to search for optimal locations of holes as well. In an example, if the ideal number of holes and size are determined, different test balls where those holes are placed in different locations may be trialed for optimally low sound generation. Accordingly, in some examples, the holes may be arranged in a pattern that minimizes sound generation while maintaining the structural integrity of the ball.

Referring now to FIG. 3G, an exemplary design for a plated ball type base is illustrated. An approximately hollow spherical shell may be formed with a plurality of holes across the surface in patterns designed to receive two different plates. There may be many other types of plate designs and internal shells consistent with this design type. The design has a set of regions designed to receive pentagonal and hexagonal shaped plates. For example, a pentagonal region 330 and a hexagonal region 331 may have a different set of holes associated with them in some examples. Referring to FIG. 3H a pentagonal plate 332 is illustrated. Referring to FIG. 3I a hexagonal plate 333 is illustrated. These various components may be molded, injection molded, printed, machined, or produced in other such manners. The components have a three dimensional surface feature that matches the shape of a sphere in some examples. For experimental purposes, a set of components was printed in Tough PLA with FDM printing techniques. As mentioned previously, the plates may be independently produced or may be connected by small filaments in their final layout as pieces with more plates. In the experiment, independent plates were printed. In some examples, the plates may have holes in the center of them which may be inserted in a receiving hole of the hollow spherical shell. In some examples, the hollow spherical shell may be produced with any of the polymeric and elastomeric materials as described herein. In the experiment, silicone adhesive was coated on the back surfaces and hole feature sidewalls and applied with pressure to the hollow spherical shell and allowed to harden. As a result, the plates were isolated from each other and from the internal spherical shell with a damping material. The spaces between the plates were also coated with silicone adhesive. In some examples, the spaces between the plates may be maintained with an air gap. In some methods of manufacture the plates may be applied with adhesive to the hollow sphere, in some other methods a heat treatment may active a heat sensitive adhesive or melt a portion of the hollow sphere surface or a coating thereupon while the plates are held against the sphere with force. In some examples, the resulting glued structure may have a subsequent injection process to fill the gaps between the plates with isolating material.

In the experimental device, the shape of the assembled plates may be called a truncated icosahedron. It may be apparent that while the experimental device may have a regular orientation of holes in the finished ball which allows for just fabricating a number of pentagonal and hexagonal shapes of the same size there may be designs with different hole locations where the associated plates require more plate types to form a ball and in the extreme each hole may have a custom plate associated with it. In the experimental device, the plates were oriented with a central hole that protruded through the inner hollow sphere and provided alignment. An additional cylindrical shape was designed onto the back of each plate that aligned with one of the smaller holes in the inner hollow sphere. It may be noted that the set of discrete plates may also be formed by a single molding process onto the inner hollow sphere structure in some examples.

Proceeding to FIG. 3J a result of testing the experimental plated ball device is illustrated. The components were printed in tough PLA on a MakerBot Replicator+ printer. An associated reference ball with 1 mm thick sidewall and the equivalent hole pattern was also printed. A dropped ball experiment was performed on each of the plated ball and reference ball. It may be observed that a significant reduction in sound at any frequency above 1 kHz results and the integrated power indicates at least a reduction of twenty times the integrated signal result may occur. In the illustration, the power amplitudes for the experimental ball 340 are plotted with the secondary y axis 341 as may be observed by the offset “0” value. The corresponding data for the reference ball 342 are plotted with the primary axis 343. In some examples balls may be made with isolated plates where other features such as internal ribs, trenches and other features described herein are also incorporated.

### Methodology

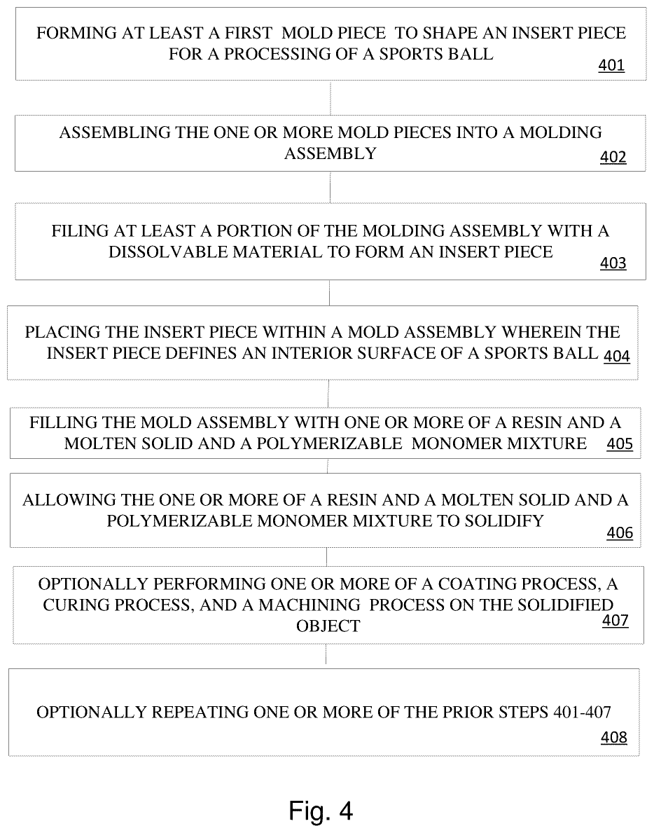

Referring now to FIG. 4, at step 401 a method may include forming at least a first mold piece to shape an insert piece for a processing of a sports ball. The method may also include at step 402 assembling the one or more molding pieces into a molding assembly. The method may include at step 403 filing at least a portion of the molding assembly with a dissolvable material to form an insert piece. The method may include at step 404 placing the insert piece within a mold assembly wherein the insert piece defines an interior surface of a sports ball. The method may include at step 405 filling the mold assembly with one or more of a resin and a molten solid and a polymerizable monomer mixture. The method may include at step 406 allowing the one or more of a resin and a molten solid and a polymerizable monomer mixture to solidify. The method may optionally include at step 407 performing one or more of a coating process, a curing process, and a machining process on the solidified object. The method may optionally continue at step 408 with repeating one or more of the prior steps 401-407.

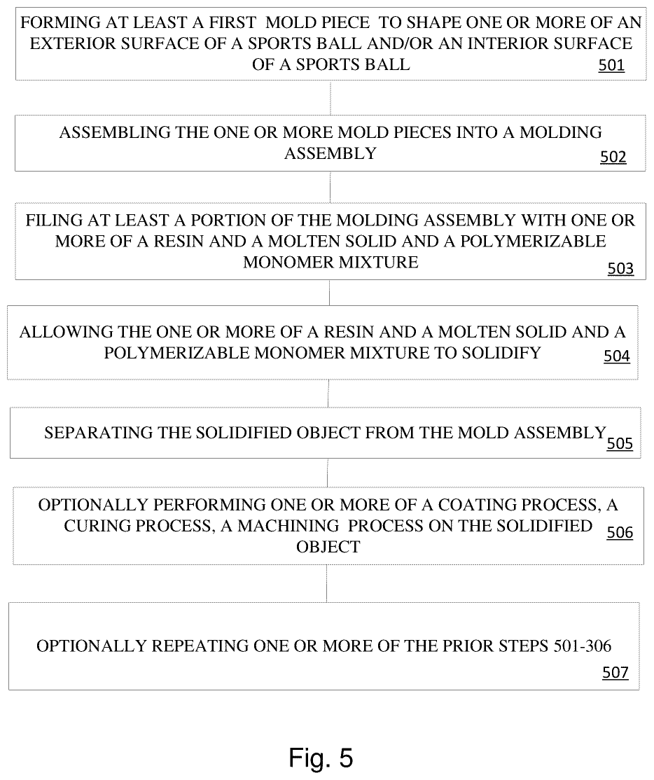

Referring now to FIG. 5, at step 501 a method may include forming at least a first mold piece to shape one or more of an exterior surface of a sports ball and/or an interior surface of a sports ball. The method may continue at step 502 with assembling the one or more mold pieces into a molding assembly. The method may continue at step 503 with filing at least a portion of the molding assembly with one or more of a resin and a molten solid and a polymerizable monomer mixture. The method may continue at step 504 with allowing the one or more of a resin and a molten solid and a polymerizable monomer mixture to solidify. The method may continue at step 505 with separating the solidified object from the mold assembly. The method may optionally continue at step 506 with performing one or more of a coating process, a curing process, a machining process on the solidified object. The method may optionally continue at step 507 with repeating one or more of the prior steps 501-506.

### SUMMARIZED ASPECTS

A general apparatus for reducing the sound level produced during a sporting activity may include a first approximately spherical shell made of at least one material. This shell may include a curved outer surface and a curved inner surface. The shell may have a plurality of penetrating holes distributed across it. Additionally, the apparatus may feature a plurality of perceived-sound reduction elements located either within the shell or on the curved inner surface, which is distally located from the outer surface towards the central point of the shell. These perceived-sound reduction elements aim to reduce emitted sound intensity or shift the frequency spectrum of emitted sound to a lower perceived-sound intensity. These features are additional to the cross-sectional area and design of the penetrating holes.

This general apparatus may also include perceived-sound reduction features that comprise one or more types of tab features formed on the curved inner surface of the first approximately spherical shell. In some of these examples, the examples may include cases where the tab features have a set of width, height, and length dimensions, forming cantilever resonator structures with resonant characteristics at specific bands of vibrational frequencies. The resonant characteristics of the tab features may overlap with one or more fundamental resonant frequencies of the first approximately spherical shell. The tab features may be formed from a damping material.

The general apparatus may include perceived-sound reduction features that include one or more types of recessed features formed into the curved inner surface of the first approximately spherical shell. In some of these examples, the recessed features may modulate the local stiffness of the first approximately spherical shell.

The general apparatus may include perceived-sound reduction features that comprise one or more types of hole sidewall features formed on the curved inner surface of the first approximately spherical shell at the periphery of each penetrating hole. Some of these examples may specify that the hole sidewall features have the shape of a frustum tube protruding past the curved inner surface of the first approximately spherical shell. In some of these examples, at least one hole may have a sidewall feature with a diaphragm at the end of the sidewall feature.

The general apparatus may include perceived-sound reduction features that comprise trenches in the outer surface of the first approximately spherical shell. Some of these examples specify that the first approximately spherical shell comprises a layered structure with at least the first material and an underlying damping material. The first material layer may form the basis of the curved outer surface, and the trenches in the outer surface may surround at least one of the penetrating holes. In some of these examples, the trenches may be filled at least in part with a damping material.

The general apparatus may include examples where the first material is a polyethylene-based polymer or a polyurethane-based polymer.

A method of forming the general apparatus may include creating a first concave-shaped molding surface to mold the exterior surface of at least a portion of a first half of the approximately spherical shell. It may also include creating a first convex-shaped molding surface to mold the interior surface of at least a portion of a first half of the approximately spherical shell, with surface features to mold features on the curved interior surface. The method may involve molding the first half of the shell using injection or rotational molding, forming the second half, similarly, creating features such as tabs, ridges, peaks, ribs, recesses, trenches, or cavities, and joining the two halves. In some of these methods, examples may include forming features such as tabs, ridges, peaks, ribs, recesses, trenches, or cavities into the shell halves utilizing a branding or welding process.

A method of forming the general apparatus may include creating a first concave-shaped molding surface to mold the exterior surface of at least a portion of a first half of the approximately spherical shell. It may also include creating a first convex-shaped molding surface to mold the interior surface of at least a portion of a first half of the shell, with a smooth curved inner surface. The method may involve molding the first and second halves of the shell, creating a second convex-shaped molding surface to mold features such as tabs, ridges, peaks, and ribs, forming these features onto the first half, and joining the two halves. In some of these methods examples may include cases where the first material is a polyethylene-based polymer or a polyurethane-based polymer, and the material of the tabs, ridges, peaks, and ribs is a damping material.

A method of forming the general apparatus may include creating a first concave-shaped molding surface to mold the exterior surface of a collection of plates defining the shape of a first half of the approximately spherical shell. It may also include creating a first convex-shaped molding surface to mold the interior surface of at least a portion of a first half of the shell, with a smooth curved inner surface. The method may involve molding the collection of plates for both halves, obtaining an inner sphere with a matching diameter to the inner face of the plates, and attaching the plates to the inner sphere using gluing or co-melting or other means of affixing the parts. In some examples features on the plate may physically attach to the inner sphere for alignment or fixing purposes.

A method of forming the general apparatus may include designing a first pass of the general apparatus to create a first ball design, fabricating the design to form a first test ball, attaching the test ball to an apparatus for a dropped steel ball test and optionally a dropped ball test, performing the tests, analyzing the data to determine the resonance frequencies, and altering the design to create additional perceived-sound reduction features or alter existing ones.

### CONCLUSION

Particular embodiments of the subject matter have been described. Other embodiments are within the scope of the following claims. In some cases, the actions recited in the claims can be performed in a different order and still achieve desirable results. In addition, the processes depicted in the accompanying figures or described in the discussion herein, do not necessarily require the particular order shown or described, or a particular sequential order, to achieve desirable results. In certain implementations, multitasking and parallel processing may be advantageous. Nevertheless, it will be understood that various modifications may be made without departing from the spirit and scope of the claimed invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

As has been mentioned, the illustrations depict aspects of exemplary embodiments, and the relative scale of illustrated features may be exaggerated for depiction of various aspects. Accordingly, the scale of features illustrated is not intended to limit the scope of the elements of the disclosure.

What is claimed is:

1. An apparatus for reduction of a sound level produced during a sporting activity, the apparatus comprising:
a first approximately spherical shell of at least a first material, wherein the first approximately spherical shell of at least the first material comprises a curved outer surface and a curved inner surface;
a plurality of penetrating holes, wherein the plurality of penetrating holes penetrate through the first approximately spherical shell of at least the first material and are distributed across the first approximately spherical shell of at least the first material; and
a plurality of perceived-sound reduction features located at one or more of:
positions within the first approximately spherical shell of at least the first material; and
positions upon the curved inner surface of the first approximately spherical shell of at least the first material, wherein the curved inner surface is distally located from the curved outer surface in a direction towards a central point of the first approximately spherical shell of at least the first material; and
wherein perceived-sound reduction may comprise one or more of:
a reduction in emitted sound intensity, and
a shift in a frequency spectrum of emitted sound to a lower perceived-sound intensity; and
wherein the plurality of perceived-sound reduction features are additional to a design of the cross-sectional area of the penetrating holes and are additional to a design of the location of the penetrating holes.

2. The apparatus of claim 1 wherein the plurality of perceived-sound reduction features comprise one or more types of tab features which are formed upon the curved inner surface of the first approximately spherical shell of at least the first material.

3. The apparatus of claim 2 wherein the one or more types of tab features have a set of width, height and length dimensions for each of the one or more types of tab features, wherein the one or more types of tab features each form a cantilever resonator structure with resonant characteristics each at a respective particular band of vibrational frequencies.

4. The apparatus of claim 3 wherein the resonant characteristics of each of the one or more types of tab features overlap with one or more fundamental resonant frequencies of the first approximately spherical shell of at least the first material.

5. The apparatus of claim 4 wherein at least one of the one or more types of tab features are formed of a damping material.

6. The apparatus of claim 1 wherein the plurality of perceived-sound reduction features comprise one or more types of recessed features which are formed into the curved inner surface of the first approximately spherical shell of at least the first material.

7. The apparatus of claim 6 wherein the recessed features modulate a local stiffness of the first approximately spherical shell of at least the first material.

8. The apparatus of claim 1 wherein the plurality of perceived-sound reduction features comprise one or more types of hole sidewall features which are formed upon the curved inner surface of the first approximately spherical shell of at least the first material at the periphery of each of the plurality of penetrating holes.

9. The apparatus of claim 8 wherein the hole sidewall features have a shape of a frustrum tube protruding past the curved inner surface of the first approximately spherical shell of at least the first material.

10. The apparatus of claim 8 wherein at least one of the hole sidewall features have a diaphragm at least at an end of the sidewall feature.

11. The apparatus of claim 1 wherein the plurality of perceived-sound reduction features comprise trenches in the outer surface of the first approximately spherical shell of at least the first material,

12. The apparatus of claim 11, wherein the first approximately spherical shell of at least the first material comprises a layered structure at least comprising the first material and an underlying damping material, wherein the first material layer forms a basis of the curved outer surface of the first approximately spherical shell and wherein the trenches in the outer surface surround at least one of the plurality of penetrating holes.

13. The apparatus of claim 12, wherein the trenches are filled at least in part with a damping material.

14. The apparatus of claim 1 wherein the first material is a polyethylene based polymer or a polyurethane based polymer.

15. A method of forming the apparatus of claim 1, the method comprising the steps:
creating a first concave shaped molding surface to mold an exterior surface of at least a portion of a first half of the approximately spherical shell of at least the first material of claim 1;
creating a first convex shaped molding surface to mold an interior surface of at least a portion of a first half of the approximately spherical shell of at least the first material of claim 1, wherein the first convex shaped molding surface comprises surface features to mold features upon the curved interior surface of at least a portion of the sports ball;
forming a first half of the approximately spherical shell of at least the first material by molding, wherein the molding step may be performed as one of injection molding or rotational molding utilizing the first concave shaped molding surface and the first convex shaped molding surface;
forming a second half of the approximately spherical shell of at least the first material by molding, wherein the molding step may be performed as one of injection molding or rotational molding utilizing the first concave shaped molding surface and the first convex shaped molding surface;
forming one or more of tabs, ridges, peaks, ribs, recesses, trenches, or cavity features into one or more of the first half of the approximately spherical shell of at least the first material and the second half of the approximately spherical shell of at least the first material; and
joining the first half of the approximately spherical shell of at least the first material and the second half of the approximately spherical shell of at least the first material.

16. The method of claim 15 wherein the method of forming one or more of tabs, ridges, peaks, ribs, recesses, trenches, or cavity features into one or more of the first half of the approximately spherical shell of at least the first material and the second half of the approximately spherical shell of at least the first material utilizes a branding or welding process.

17. A method of forming the apparatus of claim 1, the method comprising the steps:
creating a first concave shaped molding surface to mold an exterior surface of at least a portion of a first half of the approximately spherical shell of at least the first material of claim 1;
creating a first convex shaped molding surface to mold an interior surface of at least a portion of a first half of the approximately spherical shell of at least the first material of claim 1, wherein the first convex shaped molding surface comprises a smooth curved inner surface of the at least a portion of a first half of the approximately spherical shell of at least the first material;
forming a first half of the approximately spherical shell of at least the first material by molding, wherein the molding step may be performed as one of injection molding or rotational molding utilizing the first concave shaped molding surface and the first convex shaped molding surface;
forming a second half of the approximately spherical shell of at least the first material by molding, wherein the molding step may be performed as one of injection molding or rotational molding utilizing the first concave shaped molding surface and the first convex shaped molding surface;
creating a second convex shaped molding surface to mold an interior surface of at least a portion of a first half of the approximately spherical shell of at least the first material of claim 1, wherein the first convex shaped molding surface comprises one or more of tabs, ridges, peaks, and ribs;
forming one or more of tabs, ridges, peaks, and ribs onto the first half of the approximately spherical shell of at least the first material utilizing the second convex shaped molding surface; and
joining the first half of the approximately spherical shell of at least the first material and the second half of the approximately spherical shell of at least the first material.

18. The method of claim 17 wherein the first material is one of a polyethylene based polymer or a polyurethane based polymer and the material of the one or more of tabs, ridges, peaks, and ribs is a damping material.

19. A method of forming the apparatus of claim 1, the method comprising the steps:
creating a first concave shaped molding surface to mold an exterior surface of a collection of plates comprising the shape of a first half of the approximately spherical shell of at least the first material of claim 1;
creating a first convex shaped molding surface to mold an interior surface of at least a portion of a first half of the approximately spherical shell of at least the first material of claim 1, wherein the first convex shaped molding surface comprises a smooth curved inner surface of the at least a portion of a first half of the approximately spherical shell of at least the first material;
forming a collection of plates comprising the first half of the approximately spherical shell of at least the first material by molding, wherein the molding step may be performed as one of injection molding or rotational molding utilizing the first concave shaped molding surface and the first convex shaped molding surface;
forming a collection of plates comprising the second half of the approximately spherical shell of at least the first material by molding, wherein the molding step may be performed as one of injection molding or rotational molding utilizing the first concave shaped molding surface and the first convex shaped molding surface;
obtaining an inner sphere, wherein the diameter of the inner sphere matches the curved inner surface of the collection of plates; and
attaching the collection of plates comprising the first half of the approximately spherical shell of at least the first material and the collection of plates comprising the second half of the approximately spherical shell of at least the first material to the inner sphere, wherein the attaching process comprises one or more of glueing and co-melting.

20. A method of forming the apparatus of claim 1, the method comprising the steps:
designing the apparatus for reduction of a sound level produced during a sporting activity of claim 1 to create a first ball design;
fabricating the design of the apparatus of claim 1 to form a first test ball;
attaching the first test ball to an apparatus to perform a dropped steel ball test;
performing the dropped steel ball test and optionally the dropped ball test;
analyzing a set of data obtained from the testing to determine the resonance frequencies of the first ball design; and
altering the first ball design to perform one or more of creating additional perceived-sound reduction features or altering the design of existing perceived-sound reduction features.
